(19) United States
(12) Patent Application Publication
(10) Pub. No.: US 2026/0289172 A1
(43) Pub. Date: Sep. 24, 2026

(54) SYSTEM

(71) Applicant: SoftBank Group Corp., Tokyo (JP)

(72) Inventor: Misaki TANAKA, Tokyo (JP)

(73) Assignee: SoftBank Group Corp., Tokyo (JP)

(21) Appl. No.: 19/564,321

(22) Filed: Mar. 12, 2026

(30) Foreign Application Priority Data
Mar. 19, 2025 (JP) 2025-045009

(51) Int. Cl. G06F 40/40; G10L 25/63

(52) U.S. Cl. CPC G06F 40/40; G10L 25/63

(57) ABSTRACT

A system includes a processor that is configured to receive information from a user and analyze the information by using a natural language processing technique, detect an emotional state of the user on the basis of the analyzed information and generate a prompt for instructing generation of a dialogue adapted to the emotional state by using an emotion analysis engine, and generate an appropriate dialogue by using a generative AI model on the basis of the generated prompt and provide the generated dialogue to the user.

### CROSS-REFERENCE TO RELATED APPLICATION

This application is based on and claims priority under 35 USC 119 from Japanese Patent Application No. 2025-045009 filed on Mar 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional dialogue systems and conversational agents typically generate responses based on predefined rules or general-purpose models that do not sufficiently recognize or adapt to a user’s emotional state. As a result, such systems often provide responses that are inappropriate in tone, lack empathy, or fail to match the user’s psychological needs, thereby reducing user satisfaction and engagement. Furthermore, existing systems do not adequately utilize prompts tailored to emotional analysis results when interacting with generative artificial intelligence models, leading to suboptimal dialogue generation. In addition, when a user seeks consultation or counseling, conventional systems are unable to dynamically generate an optimal consultation partner character that reflects the user’s profile and consultation content, and they are also limited in their ability to analyze emotions consistently from both voice and text inputs and to use the analysis to drive emotionally adaptive dialogue generation. Accordingly, there is a need for a system that can accurately analyze user information by natural language processing, detect the user’s emotional state, generate prompts instructing generative AI models to produce emotionally adapted dialogues and consultation partners, and provide dialogues that are more appropriate and effective for the user’s emotional and consultation needs.

### SUMMARY

In order to solve the above-mentioned problems, the present invention provides a system comprising a processor, wherein the processor is configured to receive information from a user and analyze the information by using a natural language processing technique, detect an emotional state of the user on the basis of the analyzed information, and generate a prompt for instructing generation of a dialogue adapted to the emotional state by using an emotion analysis engine. The processor is further configured to use the generated prompt as input to a generative AI model, thereby generating an appropriate dialogue and providing the generated dialogue to the user. In one aspect, the processor is configured to input user information and consultation content as a prompt into the generative AI model and generate a prompt for instructing generation of an optimal consultation partner, so that a consultation partner character adapted to the user can be dynamically generated. In another aspect, the processor is configured to analyze an emotion from voice or text of the user by using the natural language processing technique, provide a result of the emotion analysis to a generative artificial intelligence unit, and generate a prompt for instructing generation of a dialogue based on the emotion. By structuring the system so that prompts reflecting user emotions and consultation content are explicitly generated and supplied to the generative AI model, the system can generate and provide dialogues and consultation partners that are better aligned with the user’s emotional state and consultation needs.

The term “processor” refers to any hardware or combination of hardware and software, including but not limited to a CPU, GPU, microcontroller, or dedicated processing circuitry, that executes instructions to perform the functions described in the present invention.

The term “system” refers to an arrangement including at least one processor and, optionally, one or more memories, communication interfaces, input/output devices, or external services, that collectively perform the operations defined in the claims.

The term “user information” refers to data related to a user, including but not limited to profile information, demographic information, preferences, behavioral history, and any other information provided explicitly or implicitly by the user.

The term “information from a user” refers to any data input, directly or indirectly, by the user, including text, voice, selections on a graphical user interface, and other interaction data that can be acquired by the system.

The term “natural language processing technique” refers to any method, algorithm, or model that processes human language in textual or transcribed form, including but not limited to tokenization, syntactic parsing, semantic analysis, sentiment analysis, and language modeling.

The term “analyze the information” refers to processing the information from the user by applying one or more natural language processing techniques in order to extract features, meanings, intents, sentiments, or other structured representations.

The term “emotional state of the user” refers to a psychological or affective condition of the user, such as happiness, sadness, anger, anxiety, neutrality, or other emotional categories or dimensions that can be inferred from the user’s information.

The term “detect an emotional state” refers to determining, estimating, classifying, or otherwise inferring the emotional state of the user based on analyzed information.

The term “emotion analysis engine” refers to a functional unit, implemented in software, hardware, or a combination thereof, that receives analyzed information and outputs a representation of the user’s emotional state, such as an emotion label, score, or distribution.

The term “prompt” refers to data, including textual data or structured data, supplied to a generative AI model to condition, guide, or instruct the content, style, or attributes of the output generated by the model.

The term “generate a prompt” refers to creating or constructing, by the processor, a new prompt or modifying an existing prompt such that it reflects at least the analyzed information, the detected emotional state, or the consultation content.

The term “dialogue adapted to the emotional state” refers to a conversation content whose tone, wording, structure, or response strategy is selected or generated in accordance with the detected emotional state of the user.

The term “generative AI model” refers to an artificial intelligence model capable of producing new content, such as text, based on an input prompt, including but not limited to large language models and other generative models.

The term “appropriate dialogue” refers to dialogue content generated by the generative AI model that satisfies predetermined criteria of relevance, coherence, safety, and suitability in view of the user’s emotional state and input.

The term “provide the generated dialogue to the user” refers to outputting the dialogue in a form perceivable by the user, such as displaying it on a screen or presenting it as synthesized speech.

The term “consultation content” refers to information expressing a topic, issue, problem, or concern that the user wishes to discuss or seek advice about.

The term “optimal consultation partner” refers to a virtual character, agent, or role definition that is determined to be suitable for interacting with the user, in view of the user information and consultation content, and that is configured to provide responses or advice.

The term “generative artificial intelligence unit” refers to a functional entity, which may include one or more generative AI models and associated control logic, that receives prompts and produces generated content such as dialogue.

The term “voice of the user” refers to audio data representing the user’s spoken utterances, whether captured in real time or retrieved from stored recordings.

The term “text of the user” refers to character-based data entered or otherwise provided by the user, including typed, transcribed, or selected textual content.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

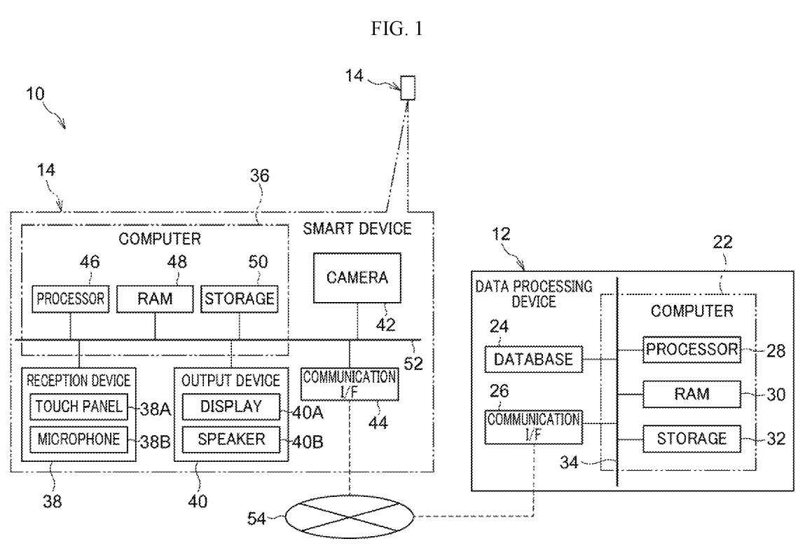

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

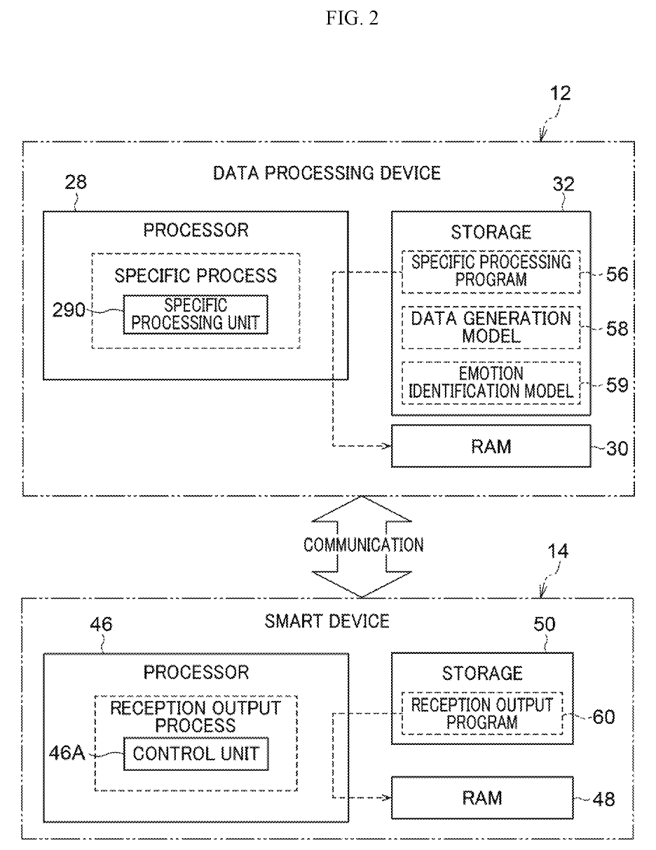

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional dialog systems that utilize a generative AI model typically forward raw user inputs, such as text or voice transcriptions, directly to the model and return the model’s response to a terminal device with only minimal post‑processing. Such systems are often designed as thin front ends around a black‑box AI service. As a result, several technical problems arise from the perspective of computer technology.

First, existing architectures generally lack a structured, machine‑interpretable representation of user attribute information, consultation content information, and dialogue history information. User inputs are handled as unstructured text streams, and the generative AI model is invoked with ad‑hoc prompts. Because no persistent, structured data model is maintained in the server, the server cannot effectively control the generative AI model’s behavior across multiple turns, and cannot reliably maintain context for long‑running counseling sessions. This leads to increased computational waste on the AI side, repeated transmission of redundant context data, and instability in the generated character behavior.

Second, conventional systems usually do not systematically generate prompt sentences based on explicit templates that encode conditions such as an age category, a tone category, and a specialty category of a virtual counseling character. Instead, prompt design is often implemented as static, hard‑coded strings. Such an arrangement restricts the server’s ability to dynamically adapt the virtual counseling character to user attribute information and consultation content information in a consistent and verifiable manner. It also hampers reuse of structured user data and dialogue history information, thereby limiting opportunities to optimize network usage and processing load.

Third, known systems rarely re‑structure the output text from the generative AI model into fine‑grained, structured elements such as character name information, personality description information, speaking style description information, initial message information, and a plurality of pieces of advice information. Without such re‑structuring, the server treats the AI output as a monolithic text block. This hinders the server’s ability to perform deterministic downstream processing, such as selective display control on the terminal device, automatic filtering or logging of specific advice items, and robust mapping between AI outputs and user interface components. As a consequence, user interface control logic becomes fragile, tightly coupled to the textual layout of the AI response, and difficult to maintain or scale.

Fourth, when the dialogue continues over multiple turns, conventional systems generally re‑send large portions of previous conversation text as part of each new prompt, without maintaining a dedicated conversation history data structure on the server side. This practice increases bandwidth consumption between the server and the generative AI model service, increases latency, and burdens the model with redundant context processing. Moreover, because the server does not hold a structured conversation history, it cannot perform fine‑grained selection of relevant historical elements to be included in each subsequent prompt, which degrades the quality and coherence of the generated responses.

Accordingly, there is a need for a system and server‑side processing architecture that: (i) receives user attribute information and consultation content information from a terminal device and stores them as structured information; (ii) generates prompt sentences in a controlled, template‑based manner using the structured information and dialogue history information; (iii) re‑structures the output text from a generative AI model into structured profile information and advice information of a virtual counseling character; and (iv) maintains conversation history data and incrementally updates additional input prompt sentences using this structured history. Such a system would improve the technical operation of the server by enabling more efficient data management, more stable behavior of the generative AI model, and more reliable control of the user interface on the terminal device.

The specific processing by the specific processing unit 290 of the data processing device 12 in Example 1 is realized by the following means.

The present invention provides a server comprising a processor and a storage medium, the processor being configured to receive, from a terminal device, user attribute information and consultation content information and store the user attribute information and the consultation content information as structured information in the storage medium, to generate, on the basis of the user attribute information, the consultation content information, and past dialogue history information, a prompt sentence that describes, in a natural language, instruction content defining personality features, speaking style, and advice policy of a virtual counseling character, and to construct the prompt sentence as input data to be supplied to a generative artificial intelligence model, to obtain, from the generative artificial intelligence model, output information including attribute information, utterance text information, and advice information of the virtual counseling character, to analyze the output information to re‑structure the output information into profile information of the virtual counseling character and a plurality of pieces of advice information, and to convert the re‑structured information into display data presentable to the terminal device, to generate, during continuation of dialogue with the virtual counseling character, conversation history data by combining the user attribute information, the consultation content information, the dialogue history information, and the profile information of the virtual counseling character, and to incrementally update additional input prompt sentences including the conversation history data as input data to be supplied to the generative artificial intelligence model, and to store dialogue response information returned from the generative artificial intelligence model in association with the conversation history data and present the dialogue response information to a user via the terminal device. This enables the server to control interaction with the generative artificial intelligence model using structured user attribute information, consultation content information, and conversation history data, thereby improving computational efficiency, context management, and user interface control in a dialog system that generates and manages a virtual counseling character.

The term “user attribute information” refers to information indicating characteristics of a user, including at least age information, gender information, preference information, and concern content information, which is acquired from a terminal device and used as input data for generating a prompt sentence and controlling behavior of a virtual counseling character.

The term “consultation content information” refers to text or equivalent data representing a topic, problem, worry, or question that a user wishes to discuss with a virtual counseling character, which is supplied from a terminal device to a server.

The term “structured information” refers to data that is stored and managed in a predefined format, such as a record, a table, or a hierarchical data structure, in which individual elements of user attribute information, consultation content information, and dialogue history information are associated with explicit fields or keys.

The term “dialogue history information” refers to information indicating past exchanges between a user and a virtual counseling character, including user messages, generated responses, timestamps, and related metadata, which is stored and updated over time to maintain conversational context.

The term “virtual counseling character” refers to a software‑implemented agent that is represented by profile information including personality features, speaking style, and advice policy, and that is configured to provide counseling‑type utterances and advice to a user through a dialog interface.

The term “personality features” refers to descriptive attributes of a virtual counseling character, such as temperament, behavioral tendencies, and characteristic ways of responding, which are expressed as natural language descriptions and used to condition generated dialog.

The term “speaking style” refers to an expression mode of a virtual counseling character, including tone, politeness level, formality, and linguistic mannerisms, which are used to control the form of utterances presented to a user.

The term “advice policy” refers to a set of guidelines or tendencies that determine how a virtual counseling character generates advice, including preferred types of suggestions, level of specificity, and constraints related to safety or domain limitations.

The term “prompt sentence” refers to a natural language sentence or set of sentences encoded as text data, which describes instruction content for a generative artificial intelligence model, including conditions for generating a virtual counseling character, conversational behavior, and advice, and which is supplied as input data to the model.

The term “generative artificial intelligence model” refers to a machine‑implemented model that has been trained on data and is configured to generate new text or equivalent content in response to an input prompt sentence, by performing numerical computations on internal parameters.

The term “attribute information of the virtual counseling character” refers to information indicating properties of the virtual counseling character, such as name, age category, role, specialization area, and other profile‑related attributes.

The term “utterance text information” refers to text data representing natural language sentences generated as messages from the virtual counseling character to the user, including initial messages and follow‑up responses.

The term “advice information” refers to text data representing one or more pieces of guidance, suggestions, or recommendations generated by the virtual counseling character for addressing the user’s consultation content information.

The term “profile information of the virtual counseling character” refers to a structured aggregation of items such as personality description information, speaking style description information, and attribute information of the virtual counseling character, which together define the character’s identity and behavior.

The term “display data” refers to data formatted for presentation on a terminal device, including text strings, layout information, and associated metadata, which is generated from structured information and suitable for rendering by a user interface.

The term “conversation history data” refers to structured information that combines user attribute information, consultation content information, dialogue history information, and profile information of the virtual counseling character, and that is used to construct updated prompt sentences for subsequent interactions with a generative artificial intelligence model.

The term “condition information” refers to data indicating constraints or specifications, such as an age category, a tone category, and a specialty category of a virtual counseling character, which are derived from user attribute information and embedded into a prompt sentence to control output of a generative artificial intelligence model.

The term “age category” refers to a classification of a virtual counseling character or user into one of a plurality of age‑related groups, such as teenager, young adult, middle‑aged, or senior, which is used to influence character design and dialog style.

The term “tone category” refers to a classification indicating a general tone of utterances, such as casual, formal, friendly, or authoritative, which is used to condition the speaking style of a virtual counseling character.

The term “specialty category” refers to a classification indicating a main domain or topic area in which a virtual counseling character is assumed to have expertise, such as work‑related stress, interpersonal relationships, or lifestyle habits.

The term “template format” refers to a predefined text or data structure containing placeholders or variables for condition information, which can be programmatically filled with user‑specific values to generate a concrete prompt sentence.

The term “section labels” refers to predefined textual markers or tags, such as “Character:”, “Initial message:”, or “Advice 1:”, which are used to delimit sections in output text from a generative artificial intelligence model for the purpose of parsing and structuring the text.

The term “heading expressions” refers to textual expressions that appear in a prominent or labeled position in generated text, indicating the beginning of sections such as a character description, an initial message, or an advice list.

The term “formatting information” refers to structural clues in generated text, such as line breaks, bullet points, numbering, or markup, which are used to detect boundaries between different types of information when structuring the output.

The term “structured data” refers to data that has been processed into a format with explicit fields, keys, or indices, such that individual elements like name information, personality description information, and advice information can be programmatically accessed and manipulated.

The term “user interface on the terminal device” refers to a software‑implemented interaction environment, such as a graphical user interface or chat interface, running on a terminal device, through which a user views profile information and utterances of a virtual counseling character and inputs messages.

The term “dialogue control method” refers to a procedure or algorithm by which the system manages the flow of interaction between a user and a virtual counseling character, including timing, ordering, and selection of messages to be displayed or sent.

In one embodiment, a server, a terminal, and a user cooperate to implement the invention.

The server is implemented as a computer system comprising at least one central processing unit (CPU), a main memory, a non‑volatile storage device such as a solid‑state drive, and a network interface. The server runs an operating system such as a general‑purpose server operating system, and executes application software implemented using a web application framework, for example a Python framework or a JavaScript framework. The server further accesses a relational or document‑oriented database management system to store structured information, and communicates with an external generative AI model service via a network using a transport protocol such as TCP/IP over HTTPS.

The terminal is implemented as a general‑purpose user device, such as a smartphone, a tablet, or a personal computer, and includes a processor, a display unit, an input unit, a network interface, and a local memory. The terminal executes a web browser or a native application, and presents a user interface that enables the user to input user attribute information and consultation content information and to view output from a virtual counseling character.

The user operates the terminal to input user attribute information and consultation content information. The user sees an input form rendered by the terminal, and supplies information such as age, gender, preferences, and a description of a concern. The user may input free text describing the concern, for example, “I feel a lot of stress at work and I cannot relax when I get home,” and may select preference items such as “reading,” “sports,” or “music.” The user then instructs the terminal to transmit this data to the server.

The terminal executes a user interface module that displays the input form, receives the input events from the user, and converts the acquired information into a structured internal representation. The terminal may, for example, assign each field to a key, such as “age,” “gender,” “preferences,” and “concern.” The terminal then transmits this structured information to the server through the network interface using an application‑layer protocol, such as HTTPS, to a predetermined application programming interface endpoint of the server.

The server receives the user attribute information and the consultation content information from the terminal, and stores them as structured information in the database. The server maps each element of the received data to fields in a data record, such that the server can later retrieve and combine the data without ambiguity. For example, the server may store an age value as an integer type, a gender value as an enumerated type, a list of preferences as an array type, and consultation text as a text type. In this way, the server maintains a persistent, structured representation of the user attribute information and the consultation content information.

The server then generates a prompt sentence to be supplied to a generative AI model. The server retrieves the structured information from the database, and applies transformation rules implemented in software. The server converts the numerical age into an age category, such as “young adult,” converts the preferences into descriptive text, and identifies keywords in the concern text using natural language processing techniques implemented by a deterministic algorithm, such as tokenization and keyword extraction based on term frequency weighting. The server then applies a template format that includes placeholders for age category, tone category, and specialty category.

For example, the server may generate the following prompt sentence:

“The user is a 32‑year‑old female whose hobbies include reading. The user is currently worried about: ‘I feel a lot of stress at work and cannot relax.’ Generate a virtual counselor character best suited to this user. First, describe the character’s personality, background, and speaking style. Then, provide an initial message that the character would send to the user and three specific pieces of advice.”

In another example, the server may generate a different prompt sentence for a different user:

“The user is a 17‑year‑old male who enjoys playing basketball and video games. He is anxious about upcoming exams. Generate a friendly, motivational virtual counselor character for this user. Describe the character’s age category, personality, and casual speaking style, and then provide an opening message and three concrete suggestions for handling exam anxiety.”

The server constructs such prompt sentences not as fixed strings, but by assembling template segments and inserting values derived from the structured data. Because the server uses explicit fields and predetermined template slots, the resulting prompt sentence consistently represents technical conditions, such as tone category and specialty category, in a form suitable for machine processing. This structured prompt generation reduces variability and ambiguity in the input to the generative AI model, thereby improving reproducibility of model outputs and reducing the need to transmit redundant descriptive context.

The server supplies the constructed prompt sentence to a generative AI model. In one embodiment, the generative AI model is a transformer‑based neural network deployed on a separate computing infrastructure. The model comprises a plurality of layers including multi‑head self‑attention layers and feed‑forward layers, each with associated weight parameters. The model performs tokenization of the input prompt sentence, converts tokens into embedding vectors, and propagates these vectors through the layers using matrix multiplications and non‑linear activation functions.

The generative AI model is trained in advance using a supervised or self‑supervised learning procedure. During training, the model receives input sequences and reference output sequences, computes a prediction, and evaluates a loss function such as cross‑entropy between predicted token distributions and target tokens. The model updates weight parameters using an optimization algorithm such as stochastic gradient descent or a variant such as Adam. The training hardware includes at least one graphics processing unit or a specialized accelerator, and the model is trained on a large corpus including dialog data. This training procedure enables the model to generate coherent natural language responses conditioned on prompt sentences.

The server does not change the model weights at runtime in a typical deployment but instead uses the pretrained weights for inference. However, the server controls the input to the generative AI model using the structured prompt sentence, and additionally controls sampling parameters such as the maximum number of tokens to generate and a temperature parameter that influences randomness. Because the server manages the data that is supplied to the model and the parameters used for inference, the server can reduce the amount of redundant context transmitted to the model, and can control the computational burden on the model side.

After the generative AI model processes the prompt sentence, the model outputs a sequence of tokens which are then converted into output text. The server receives this output text and performs a re‑structuring operation. The server uses section labels, heading expressions, or formatting patterns inserted according to the template. For instance, the prompt sentence may instruct the model to format the output as:
“Character:
Name: [name]
Personality: [description]
Speaking style: [description]
Initial message: [message]
Advice 1: [text]
Advice 2: [text]
Advice 3: [text]”

The server analyzes the received text and detects sections by searching for labels such as “Character:”, “Initial message:”, and “Advice 1:”. The server applies deterministic parsing rules, such as splitting text on line breaks and trimming whitespace, and maps substrings between labels to specific fields in a structured data object. The server then stores the resulting profile information of the virtual counseling character, including name, personality description, and speaking style description, and stores each piece of advice as a separate element in a list. This process converts an unstructured text sequence into structured data that can be accessed by index, enabling the server to perform precise operations such as selectively updating only the advice portion without regenerating the entire character description.

By representing both input and output as structured data, the server improves data management and computational efficiency. For example, when a user continues a counseling session, the server can reuse the stored profile information of the virtual counseling character and only request new advice or follow‑up messages from the generative AI model. The server therefore does not need to include the full character description in every prompt sentence, thereby reducing the size of data transmitted to the generative AI model and the computation required by the model to re‑interpret repeated content.

The server maintains conversation history data that combines user attribute information, consultation content information, profile information of the virtual counseling character, and a sequence of past messages. The server stores each user message and each generated response with an associated timestamp and an identifier linking the message to a session. The server may store only a subset of the history in active memory, while archiving older messages in the database. The server then selects a subset of the history to include in an additional prompt sentence, for example by applying a heuristic that retains only the most recent messages or the messages that contain domain‑specific keywords. This selection reduces the token count of the prompt sentence, thus lowering network bandwidth and computational load and improving latency.

In one example, when a user sends a follow‑up question such as “What can I do during my lunch break to feel less stressed?”, the server retrieves the character profile and the last few user and character messages. The server then constructs an additional prompt sentence such as:
“You are a virtual counselor character named Ayaka. Your personality is calm, empathetic, and reflective. You love reading novels and often use stories as metaphors. You are talking to a 32‑year‑old woman whose hobby is reading and who feels a lot of stress at work and cannot relax.

Previous conversation:
User: [previous user message]
Ayaka: [previous AI response]

New user message: ‘What can I do during my lunch break to feel less stressed?’

Please respond as Ayaka, in a gentle and supportive tone, with 2–3 concrete suggestions that can be performed during a typical lunch break.”

Because the server explicitly specifies the speaking style and identity of the virtual counseling character, and because the server restricts the history to relevant exchanges, the generative AI model can generate a coherent and context‑aware response while processing fewer tokens. This improves technical performance in terms of response time and computational resource consumption.

The terminal receives the structured data of the character profile and the advice, and renders them via the user interface. The terminal may display the character name and personality description at the top of a chat window, show the initial message as a speech bubble, and list advice items as selectable options. The terminal may also send user selections back to the server as new messages. The terminal thus uses the structured nature of the data to implement interface behaviors such as highlighting certain advice items or allowing the user to save particular advice.

The described architecture improves computer technology for several reasons. First, by converting raw text into structured information at both input and output, the server can implement efficient indexing, caching, and partial update mechanisms. For example, the server can cache character profiles separately from advice lists and reuse them across multiple sessions, reducing redundant computations and database accesses. Second, by using template‑based prompt generation with explicit condition information, the server can systematically control the generative AI model’s behavior, leading to more stable outputs and reducing the need for repeated trial‑and‑error prompt adjustments, which would otherwise consume additional compute and network resources.

Third, by managing conversation history data and selecting relevant subsets for each prompt sentence, the server reduces the amount of context that must be re‑processed by the generative AI model at each interaction. The causal relationship between this selective context management and the technical effects is clear: fewer tokens sent per request directly reduce data transmission size and directly reduce the number of internal matrix multiplications performed by the model during attention calculations, leading to lower latency and improved throughput. Fourth, by re‑structuring the model output into structured data, the server enables deterministic user interface control and downstream processing, which reduces the need for ad‑hoc string manipulation on the terminal and lowers the chance of errors when the output format changes slightly.

In another embodiment, the server may use different types of generative AI models. For example, the server may use a smaller, locally hosted generative language model for part of the processing, such as generating only minor variations in phrasing while relying on a larger external model for core character generation. In such an embodiment, the server can select between models based on the required output length and complexity, balancing accuracy and computation cost. The server can also adjust sampling parameters or apply post‑processing filters based on the structured representation of the user’s emotional state or domain of concern.

In a further embodiment, the server may incorporate additional rule‑based modules that operate on structured data in parallel with the generative AI model. For instance, the server may implement a rule set that checks whether any generated advice violates safety constraints or domain restrictions, such as providing medical diagnoses or legal judgments. If such a violation is detected in a piece of advice, the server may either discard that advice and request a replacement from the generative AI model using an updated prompt sentence, or replace the advice with a predefined safety message. This combination of model‑based generation and deterministic rule evaluation results in a hybrid processing pipeline that achieves both flexibility and reliability.

In another embodiment, the terminal may implement additional local processing such as caching previously received character profiles and advice for offline viewing. The terminal may also adjust display formats based on available screen size, for example showing a condensed list of advice items on a small screen or expanded descriptions on a large display. Because the server delivers structured data, the terminal can perform such adaptations without parsing free‑form text, reducing implementation complexity and processing load on the terminal.

Across these embodiments, the server, the terminal, and the user interact through specific data structures and algorithmic operations that extend beyond a generic automation of human counseling. The system as a whole provides self‑consistent management of user attribute information, consultation content information, prompt sentences, generative AI model outputs, and conversation history data, thereby improving processing efficiency, accuracy of context maintenance, and robustness of the dialog system.

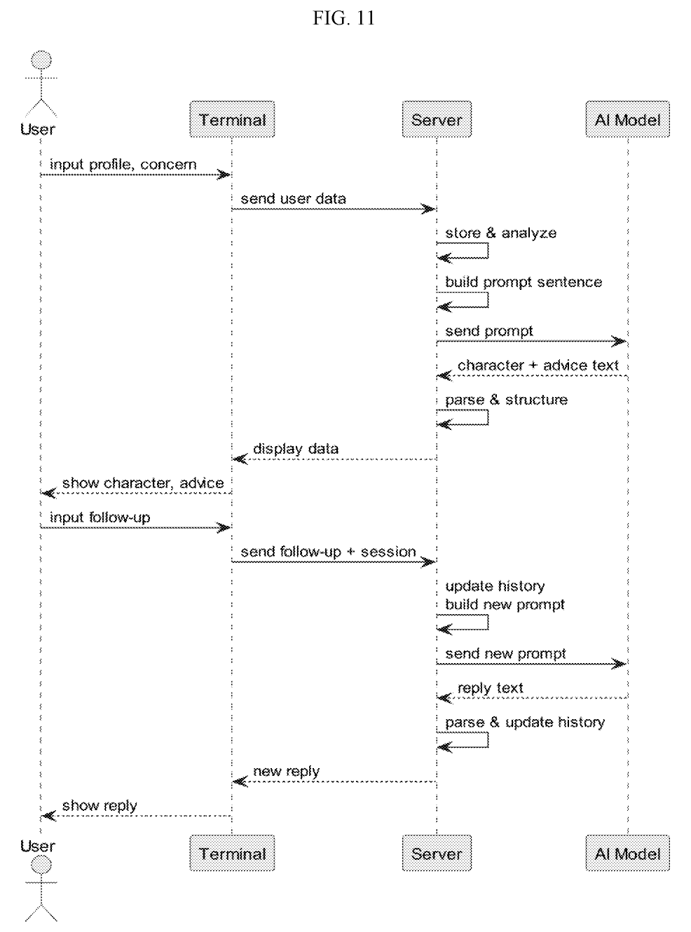

The following describes the processing flow using FIG. 11.

### Step 1

User operates the terminal to input consultation data.

User views an input screen on the terminal and enters user attribute information such as age, gender, and preferences, and enters consultation content information as free text. The input is, for example, “I feel a lot of stress at work and I cannot relax when I get home.” The output is raw input events and text values in the terminal’s memory.

### Step 2

Terminal constructs structured user data and sends it to the server.

Terminal receives the raw input values from the user interface components, validates basic formats (for example, checks that age is numeric and mandatory fields are not empty), and assembles them into a structured internal record with fields such as “age,” “gender,” “preferences,” and “concern.” The input is the raw text and selection values; the output is structured user data, which the terminal transmits to the server using a network protocol such as HTTPS.

### Step 3

Server receives and parses the structured user data.

Server accepts the HTTPS request from the terminal at a predetermined endpoint, reads the request body, and parses the structured user data using a JSON parser or equivalent. The input is the structured user data as a serialized message; the output is an in‑memory object representing user attribute information and consultation content information with explicit fields.

### Step 4

Server stores user attribute information and consultation content information as structured information.

Server maps each field of the in‑memory object to columns or keys in a database schema and issues a write operation to a database management system. The input is the parsed user data object; the output is a stored record containing structured information, associated with a session identifier or user identifier.

### Step 5

Server derives condition information for a virtual counseling character.

Server reads the stored structured information from the database, and computes derived attributes such as an age category, a tone category, and a specialty category. For example, server maps “32” to “young adult,” maps “work stress” keywords to a “work‑related stress” specialty, and maps user preferences such as “reading” to a “calm and reflective” tone category. The input is the structured user data; the output is condition information that specifies character categories and desired communication style.

### Step 6

Server generates a prompt sentence using a template format.

Server selects a template text that includes placeholders for age category, preferences, concern text, and condition information, and programmatically replaces the placeholders with concrete values derived in Step 5. The input is the condition information and the original consultation content text; the output is a complete prompt sentence in natural language, for example:

“The user is a 32‑year‑old female whose hobbies include reading. The user is currently worried about: ‘I feel a lot of stress at work and cannot relax.’ Generate a virtual counselor character best suited to this user. First, describe the character’s personality, background, and speaking style. Then, provide an initial message that the character would send to the user and three specific pieces of advice.”

### Step 7

Server constructs input data for a generative AI model and sends it.

Server encapsulates the prompt sentence into a request structure required by the generative AI model, sets inference parameters such as maximum output length and temperature, and transmits the request to a generative AI model endpoint over the network. The input is the prompt sentence and control parameters; the output is a model request message delivered to the generative AI model service.

### Step 8

Server receives output text from the generative AI model.

Server waits for a response from the generative AI model, receives a message containing generated text that includes a character description, an initial message, and a plurality of pieces of advice, and parses the message using a JSON parser or equivalent. The input is the generative AI model response message; the output is raw output text in memory, such as a single string or a sequence of tokens.

### Step 9

Server parses and re‑structures the output text into profile information and advice information.

Server analyzes the output text by searching for section labels, headings, or formatting patterns such as “Character:”, “Initial message:”, and “Advice 1:”. Server splits the text at these markers, trims extraneous whitespace, and assigns each segment to a corresponding field such as character name, personality description, speaking style description, initial message text, and individual advice texts. The input is the raw output text from the generative AI model; the output is structured data comprising profile information of the virtual counseling character and a list of advice items.

### Step 10

Server converts structured character data into display data for the terminal.

Server formats the structured data into a representation suitable for rendering on the terminal, for example by grouping the character profile into a “header” section and the advice items into a “message list.” Server may add presentation hints such as ordering, labels, or types (for example, “profile,” “initial_message,” “advice”). The input is the structured character data; the output is display data that can be directly consumed by the user interface logic on the terminal.

### Step 11

Server sends display data to the terminal and stores conversation history.

Server transmits the display data to the terminal via an application‑layer response, and in parallel records the generated profile information and advice texts as part of conversation history in the database, associating them with the session identifier. The input is the structured character data and session information; the output is (i) a response message to the terminal containing display data, and (ii) updated conversation history information stored on the server.

### Step 12

Terminal receives display data and renders the virtual counseling character.

Terminal parses the received display data, generates user interface components for the character profile, the initial message, and the advice items, and draws them on the display. The input is the display data from the server; the output is a rendered user interface showing the virtual counseling character and the advice on the terminal screen.

### Step 13

User views the displayed character and inputs a follow‑up message.

User reads the initial message and advice, and then enters a follow‑up question, such as “What can I do during my lunch break to feel less stressed?” into an input field on the terminal. The input is the visual display of the character and advice; the output is new text input that expresses an additional consultation request.

### Step 14

Terminal packages the follow‑up message with session information and sends it to the server.

Terminal attaches a session identifier or conversation identifier to the follow‑up text, constructs a structured message including the user’s new message and a reference to the existing session, and sends this message to the server via the network. The input is the new free‑text message and session metadata; the output is a structured follow‑up request transmitted to the server.

### Step 15

Server updates conversation history data and builds an additional prompt sentence.

Server retrieves existing conversation history associated with the session, including the stored character profile and the last several user and character messages. Server appends the new user message to the history, selects a subset of recent exchanges according to predefined rules, and combines this subset with the stored profile information to form conversation history data. Server then generates an additional prompt sentence that includes a role description for the virtual counseling character, excerpts of the previous conversation, and the new user message, for example:

“You are a virtual counselor character named Ayaka. Your personality is calm, empathetic, and reflective. You love reading novels and often use stories as metaphors. You are talking to a 32‑year‑old woman whose hobby is reading and who feels a lot of stress at work and cannot relax.

Previous conversation:

User: [previous user message]

Ayaka: [previous AI response]

New user message: ‘What can I do during my lunch break to feel less stressed?’

Please respond as Ayaka, in a gentle and supportive tone, with 2–3 concrete suggestions that can be performed during a typical lunch break.”

The input is the updated conversation history data; the output is a new prompt sentence tailored to the ongoing session.

### Step 16

Server sends the additional prompt sentence to the generative AI model and processes the new response.

Server encapsulates the additional prompt sentence in a model request, transmits it to the generative AI model, receives the model’s new output text, and parses and re‑structures the text using the same procedure as in Steps 8 and 9, focusing on the new advice responses. The input is the additional prompt sentence and existing character context; the output is structured follow‑up response data that includes the next utterance of the virtual counseling character and additional advice information.

### Step 17

Server delivers the follow‑up response to the terminal and maintains updated history.

Server appends the new structured follow‑up response to the conversation history in the database, then converts the relevant parts into display data for the terminal. The input is the structured follow‑up response and the existing history; the output is (i) an updated conversation history record on the server and (ii) a response carrying the next message of the virtual counseling character to be shown on the terminal.

### Step 18

Terminal updates the dialog view and continues interaction with the user.

Terminal receives the follow‑up response, inserts the new virtual counseling character message into the chat view, and scrolls or refreshes the display so that the user can see the latest advice. The input is the follow‑up display data from the server; the output is an updated user interface that enables the user to continue the counseling dialog in a technically coherent and context‑aware manner.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional dialog systems that utilize artificial intelligence to support product or service selection generally treat the output of a generative AI model as static text to be shown to the user. Such systems are typically configured so that the AI model merely generates generic recommendations or conversational responses, while the surrounding application logic performs only simple display processing. As a result, these systems do not tightly integrate the generative AI output with structured data processing, such as database search condition generation, user history management, or adaptive prompt construction. Consequently, it is difficult to achieve high-precision personalization and to improve the efficiency and reliability of recommendation processing itself as a computer-implemented technical process.

In particular, in many existing architectures, user attribute information and request content information are passed to a model in an ad hoc manner as unstructured text, and the model’s response is not systematically analyzed to extract machine-usable attribute terms (for example, color, category, price range, usage purpose) that can be directly converted into database query conditions. Furthermore, user interaction history and purchase history are often stored only at the application level and are not fed back in a structured way into subsequent prompt construction. As a result, the system cannot dynamically adapt the behavior of the virtual dialogue partner or the search logic in response to accumulated user behavior, thereby limiting both personalization accuracy and computational efficiency.

Moreover, conventional systems frequently separate sentiment analysis or emotional adaptation from the prompt design process, leading to a situation in which the emotional state of the user is not reflected in how the prompt is constructed for the generative AI model. This separation causes suboptimal utilization of computational resources because the model repeatedly generates context that could instead be determined or constrained by system-level logic. In addition, continuous dialog sessions are generally handled as a series of independent calls to the generative AI model, without robust management of dialogue history and without systematic generation of extended prompt sentences that incorporate this history as structured context. This leads to redundant computation and reduced predictability of the system’s behavior.

Therefore, there is a need for an improved computer-implemented system and method that: (i) converts user attribute information and request content information into structured data, (ii) generates prompt sentences that explicitly define a virtual dialogue partner character and the role of such character, (iii) uses the output of a generative AI model not only for display but also as a source of structured attribute terms for database queries, (iv) accumulates user selection results and purchase processing results as user history information and feeds this information back into subsequent prompt generation, and (v) dynamically adapts the prompt sentence based on the user’s emotional state and dialogue history. By tightly coupling prompt engineering, generative AI model interaction, database search, and user history management within a single processing pipeline, it becomes possible to improve the technical performance of the computer system, including recommendation relevance, processing efficiency, and controllability of dialog behavior.

The specific processing by the specific processing unit 290 of the data processing device 12 in Application Example 1 is realized by the following means.

The present invention provides a server comprising a processor configured to acquire attribute information and request content information received from a user via a terminal and generate structured data including the attribute information and the request content information, generate a prompt sentence based on the structured data, the prompt sentence defining personality information and role information of a virtual dialogue partner character corresponding to the user and instructing generation of advice regarding a product or a service by the virtual dialogue partner character, input the prompt sentence into a generative artificial intelligence model and, by numerical computation processing performed by the generative artificial intelligence model, cause generation of dialogue information including profile information of the virtual dialogue partner character and advice information adapted to the attribute information and the request content information of the user, extract attribute terms indicating at least one of color, category, price range, and usage purpose from the dialogue information, generate search conditions for a database in which information on the product or the service is stored based on the attribute terms, and acquire candidate information of a recommendation target from the database by using the search conditions, generate response data including the profile information of the virtual dialogue partner character, the advice information, and the candidate information, and transmit the response data to the terminal to cause display on the terminal, acquire a selection result and a purchase processing result based on the candidate information from the user, record the selection result and the purchase processing result as user history information, reflect the user history information as generation conditions when generating the prompt sentence in a subsequent processing, acquire additional input information and dialogue history information transmitted from the terminal, generate an extended prompt sentence including the dialogue history information and re-input the extended prompt sentence into the generative artificial intelligence model to cause continuous dialogue by the virtual dialogue partner character and updating of the advice information, and analyze emotion-related information acquired from the user and expressions included in the dialogue information obtained from the generative artificial intelligence model and dynamically generate the prompt sentence so as to change at least one of a speaking manner, a tone, and contents of the candidate information presented by the virtual dialogue partner character in accordance with an emotional state of the user. This enables the server to implement an integrated processing pipeline in which user information is converted into structured data, prompt sentences are adaptively generated and refined using user history and emotional state, output of the generative AI model is converted into database search conditions for efficient retrieval of recommendation candidates, and continuous dialog with the virtual dialogue partner character is maintained while improving the relevance, consistency, and computational efficiency of AI-driven recommendation processing as a whole.

The term “processor” refers to a hardware and/or software execution unit, such as a central processing unit, a microprocessor, or a processing circuit, configured to execute program instructions to perform the functions described in the present specification.

The term “terminal” refers to an information processing apparatus, such as a mobile device, a smartphone, a tablet, a personal computer, or any user interface device, that exchanges data with the server and presents information to the user.

The term “user” refers to a human operator who interacts with the terminal and the system by providing input information and receiving output information, including recommendations and dialogue content.

The term “attribute information” refers to data items indicating characteristics of the user, such as demographic information, preference information, behavioral information, or other profile information that can be utilized for personalization.

The term “request content information” refers to data items indicating a need, intention, inquiry, or problem presented by the user, including text describing a desired product, service, or advice to be obtained from the system.

The term “structured data” refers to data organized according to a predefined schema or format, such as key-value pairs, tables, or objects, that enables programmatic processing, searching, and transformation.

The term “prompt sentence” refers to a natural-language or semi-structured instruction string, provided as input to a generative artificial intelligence model, that specifies desired behavior, role, or output characteristics of the model.

The term “virtual dialogue partner character” refers to an artificial entity, represented by profile attributes such as personality, role, and speaking style, that engages in dialogue with the user through text or other media, and that is generated or controlled based on the prompt sentence and the model output.

The term “personality information” refers to data describing traits or characteristics of the virtual dialogue partner character, such as friendliness, formality, expertise level, or communication style.

The term “role information” refers to data describing a functional or professional role assigned to the virtual dialogue partner character, such as advisor, consultant, guide, or assistant, which determines the type of advice or dialogue to be provided.

The term “generative artificial intelligence model” refers to a machine learning model, such as a neural network-based language model, configured to generate output data including text or other content based on an input prompt sentence and internal learned parameters.

The term “dialogue information” refers to data generated by the generative artificial intelligence model in response to a prompt sentence, including at least one of character profile descriptions, advice sentences, questions, and other conversational content.

The term “profile information” refers to a subset of the dialogue information that specifies properties of the virtual dialogue partner character, including personality information, role information, and other descriptive attributes.

The term “advice information” refers to a subset of the dialogue information that provides recommendations, explanations, or guidance to the user regarding products, services, or actions to be taken.

The term “attribute terms” refers to words, phrases, or tokens extracted from the dialogue information that denote search-relevant properties of products or services, such as color, category, price range, or usage purpose.

The term “color” refers to a visual property of a product, designated by a name or code, which can be used as a filtering condition in a database search.

The term “category” refers to a classification label representing a type or group of products or services, such as clothing, electronics, or accessories, which can be used to narrow a search scope.

The term “price range” refers to a numerical interval or qualitative band indicating a lower and upper bound of a price, used as a condition for filtering products or services in a database.

The term “usage purpose” refers to a description of an intended use scenario or context for a product or service, such as daily use, business use, outdoor use, or formal occasions.

The term “database” refers to an organized collection of data stored in a storage system, such as a relational database or a non-relational database, that supports querying, retrieval, and updating of product or service information.

The term “search conditions” refers to one or more constraints, filters, or query parameters derived from attribute terms or other structured data, which are applied to a database to retrieve matching records.

The term “candidate information” refers to data items representing one or more products or services retrieved from the database based on search conditions and proposed as recommendations to the user.

The term “response data” refers to data generated by the processor and transmitted to the terminal, including at least the profile information of the virtual dialogue partner character, the advice information, and the candidate information.

The term “selection result” refers to information indicating a choice made by the user among the candidate information, such as a selected product identifier, option, or configuration.

The term “purchase processing result” refers to information indicating a status or outcome of a transaction related to a selected product or service, including at least order confirmation, payment completion, or failure status.

The term “user history information” refers to accumulated data associated with a user, including selection results, purchase processing results, and optionally past interactions, which are used for subsequent processing and personalization.

The term “additional input information” refers to further data provided by the user during an ongoing session, such as follow-up questions, refined preferences, or constraints not included in the initial request content information.

The term “dialogue history information” refers to data representing past exchanges between the user and the virtual dialogue partner character, including previous prompt sentences, model outputs, and user responses.

The term “extended prompt sentence” refers to a prompt sentence that incorporates dialogue history information and optionally additional input information, so as to continue or refine an ongoing conversation with the generative artificial intelligence model.

The term “emotion-related information” refers to data indicative of an emotional state of the user, obtained from user input, interaction patterns, or external analysis modules, such as indications of satisfaction, frustration, or uncertainty.

The term “emotional state” refers to a state of the user’s feelings or mood at a given time, such as positive, negative, neutral, or more specific emotions, which can be used to adapt the behavior of the virtual dialogue partner character.

The term “speaking manner” refers to a style of expression used by the virtual dialogue partner character, including formality level, sentence complexity, and degree of politeness.

The term “tone” refers to an affective quality or attitude conveyed by the virtual dialogue partner character’s expressions, such as enthusiastic, calm, sympathetic, or objective.

The term “integrated processing pipeline” refers to a sequence of interconnected processing stages implemented by the server, in which user information acquisition, structured data generation, prompt sentence generation, generative model invocation, attribute term extraction, database searching, user history recording, and adaptive prompt refinement are executed in a coordinated manner.

In one embodiment, a server, a terminal, and a network cooperate to implement the claimed system. The server includes at least one processor, a main memory, a non-volatile storage device, a network interface, and an optional hardware accelerator such as a graphics processing unit. The server runs a general-purpose operating system, such as a UNIX-compatible operating system, and application software including a web application framework and a database management system. The terminal includes a processor, a memory, a display, an input device such as a touch panel, and a wireless communication module. The terminal runs an operating system for mobile devices or personal computers and executes a web browser or a dedicated client application.

The server executes a program stored in the non-volatile storage device. The program is loaded into the main memory and executed by the processor. The program is configured to perform data acquisition, data transformation, prompt sentence generation, communication with a generative AI model, structured extraction from model outputs, database querying, user history management, and adaptive prompt refinement. The server uses a relational database management system to persist product information, service information, and user history information.

The server uses a generative AI model that is implemented as a neural network-based language model. In one embodiment, the generative AI model is a transformer-based neural network that includes a plurality of self-attention layers, feed-forward layers, and normalization layers. The generative AI model is trained in advance on large-scale text data using a supervised or self-supervised learning algorithm. During training, the generative AI model receives tokenized text sequences and outputs probability distributions over possible next tokens. The training process uses a loss function such as cross-entropy error between predicted token distributions and ground-truth tokens. The server updates model parameters using a gradient-based optimization algorithm, such as stochastic gradient descent with momentum or adaptive moment estimation, in which the server computes gradients of the loss function with respect to model weights, updates weights in a direction that reduces error, and repeats this process for many batches of data. The server may use data augmentation techniques such as random masking of tokens, shuffling of sentence order within constraints, or synonym replacement to improve generalization.

The server stores the generative AI model parameters in a model storage area and loads the parameters into memory when invoking the model. The server uses a tokenizer module to convert input prompt sentences into token identifiers, and uses an embedding module to convert token identifiers into vector representations. The server feeds the vector representations through the transformer layers, which perform matrix multiplications and non-linear activation functions, to generate output token probabilities. The server then uses a decoding strategy, such as greedy decoding, top-k sampling, or nucleus sampling, to generate text sequences from the probability distributions. The server uses generation parameters such as maximum token length, temperature, and top-p thresholds to control diversity and determinism of the generated text.

The terminal transmits attribute information and request content information to the server. In one example, the terminal runs a browser or an application and presents to the user an input interface that includes fields for age, gender, style preference, budget, and a free-text description of a request. The user interacts with the terminal via the touch panel or keyboard and enters information such as “male, 30s, prefers casual style, looking for a new jacket and does not know which color suits him.” The terminal internally holds this information in a structured object and transmits it to the server over a secure communication channel.

The server receives the attribute information and request content information via the network interface and stores the received data as structured data in memory. The server uses a data schema that includes keys representing items such as “age_range,” “gender,” “style_preference,” “budget,” and “request_text.” The server optionally normalizes the attribute information to standardized labels, for example by mapping numeric ages to age ranges and mapping free-form style strings to controlled vocabulary entries. The server then stores such structured data in a temporary cache and, optionally, in a user session table within the database.

The server constructs a prompt sentence based on the structured data. The server maintains a collection of prompt templates stored in configuration files or database records. Each prompt template includes placeholders that correspond to attributes such as age, gender, style preference, and request text. The server selects an appropriate template based on the user’s attributes and the intended advisory domain. The server performs string substitution or template rendering to fill placeholders with normalized attribute values. The server thereby generates a prompt sentence that defines personality information and role information of a virtual dialogue partner character and instructs the generative AI model to generate advice information.

For example, the server may generate a prompt sentence such as:

“The user is a man in his 30s who prefers a casual style. He is looking for a new jacket and is unsure which color suits him. Generate a friendly fashion advisor character who specializes in casual men’s fashion. First, describe the character’s personality and appearance in several sentences. Then have this character give concrete color recommendations for a jacket, taking into account the user’s age, casual style preference, and versatility for everyday wear.”

In another example, the server may generate a prompt sentence such as:

“The user is a woman in her 20s who enjoys minimalist and monochrome outfits. She is looking for sneakers that match her usual style and can be worn both to work and on weekends. Generate a calm, knowledgeable advisor character who specializes in minimalist women’s fashion. Output a concise description of the character and detailed recommendations specifying preferred sneaker colors, material types, and styling tips that can be directly used to filter an online catalog.”

The server transmits the prompt sentence to the generative AI model. When the model resides on the same server, the server calls the inference function of the local model module. When the model is provided as a remote service, the server uses an HTTP client library to send the prompt sentence to the model service and receives a response. In either case, the server converts the prompt sentence into token sequences, processes the tokens through the transformer network, and generates dialogue information including character profile information and advice information.

The server applies a post-processing module to the dialogue information. The server analyzes the generated text using deterministic rules and pattern matching techniques. The server identifies attribute terms that denote color, category, price range, and usage purpose. The server maintains dictionaries and regular expression patterns that associate specific lexical units and phrases with ontology labels. For example, the server maps words such as “navy,” “olive,” and “beige” to internal color codes, maps phrase patterns such as “under 100 dollars” or “affordable” to predefined price range codes, and maps phrases such as “for business use” or “for outdoor activities” to usage purpose codes.

The server generates search conditions for a product or service database using the extracted attribute terms. The server converts color codes, category labels, price range codes, and usage purpose codes into query parameters. The server constructs a structured query, such as a relational query, that filters records by category, color, price range, and usage purpose. The server executes the query through a database driver and retrieves candidate information that includes product identifiers, descriptions, prices, stock information, and image references.

The server combines the candidate information with the character profile information and advice information to form response data. The server assigns the profile information to fields that represent the virtual dialogue partner character’s name, personality attributes, and role description. The server assigns the advice information to fields that hold textual recommendations. The server assigns the candidate information to a list that can be used by the terminal to display recommended products or services. The server serializes this response data using a structured format and transmits the serialized data to the terminal.

The terminal receives the response data and renders a user interface. The terminal uses a rendering engine of a browser or an application framework to draw a character representation, for example an avatar, along with the textual profile and advice. The terminal displays a list or grid of recommended items including images, names, and prices. The user reads the advice and can interact with the character, for example by entering follow-up questions such as “What about black?” or by applying further filters through the interface.

The server receives additional input information and dialogue history information from the terminal. The server stores dialogue history information as a sequence of records that include prompt sentences, generated dialogue information, and user responses. The server generates an extended prompt sentence by concatenating or otherwise encoding a subset of the dialogue history and the additional input. The server uses rules to truncate or summarize older parts of the history to maintain a context length suitable for the generative AI model. By including dialogue history in the extended prompt sentence, the server enables the model to generate follow-up advice that is contextually consistent and avoids repetition.

The server also evaluates emotion-related information. The server analyzes text provided by the user using an emotion classifier that is implemented as a separate machine learning model or as part of the generative AI model’s output. In one embodiment, the server uses a neural network classifier trained on labeled emotional text data. The classifier receives feature vectors derived from token embeddings and outputs probabilities for emotional classes such as satisfaction, confusion, frustration, or excitement. The server uses these probabilities to determine an emotional state. The server then modifies parameters in the prompt template, such as desired tone and speaking manner of the virtual dialogue partner character. For example, if the emotional state indicates confusion, the server may alter the prompt sentence to instruct the character to speak more slowly, provide more detailed explanations, and offer reassurance.

The server records selection results and purchase processing results in the user history information. When the user selects a recommended item and completes a purchase using the terminal, the server writes records to an orders table and a user history table. These records include product identifiers, selected attributes such as size and color, purchase timestamps, and any relevant feedback. In subsequent sessions, the server retrieves the user history information and incorporates it into the structured data used for prompt generation. For instance, if the history indicates that the user repeatedly selects dark colors and mid-range price items, the server encodes these preferences into the prompt template and instructs the virtual dialogue partner character to emphasize similar items or explain when deviating from prior preferences.

The server thereby improves computational efficiency and accuracy compared to systems that rely on manual or ad hoc methods. By converting unstructured user input and generative AI output into structured data, the server can generate precise database queries and avoid scanning irrelevant items. By extracting attribute terms at the application layer using deterministic algorithms, the server reduces the need for the generative AI model to perform complex reasoning about catalog structure, thereby lowering computational load on the model. By maintaining and reusing user history within prompt sentences, the server reduces the need to repeatedly infer the same preferences from scratch, shortening necessary context and improving processing speed.

The system achieves technical advantages beyond mere automation of human recommendation tasks. The server uses the neural network’s generative capacity in combination with structured extraction and rule-based mapping to constrain and reuse model outputs as machine-readable signals. This architecture improves data management by explicitly linking free-text dialog content to database schema attributes. It also improves calculation efficiency by allowing the server to replace repeated calls for generic catalog exploration with targeted queries derived from attribute terms. Further, the server reduces communication load between the terminal and the server, because the terminal does not need to transmit the entire catalog or multiple intermediate lists; instead, the server transmits only candidate information filtered according to interpretation of the generative AI outputs.

In another embodiment, the server uses alternative neural architectures, such as a sequence-to-sequence model with attention or a hybrid rule-based and neural model. The server may deploy the generative AI model on a local hardware accelerator cluster or on remote computing infrastructure. The terminal may be implemented as a dedicated application using a native user interface toolkit or as a web-based interface. The database may be a relational database, a key-value store, or a graph database; attribute term extraction rules may be stored in a configuration file, in a rule engine, or in a learned classifier. In yet another embodiment, the virtual dialogue partner character is represented not only by text but also by synthesized speech or visual gestures, where the server controls the generation of such media based on the same structured profile information and advice information.

Because the server is configured to integrate generative AI outputs with structured attribute extraction, database querying, and history-based adaptive prompt generation, the system provides a specific technological solution to improve recommendation processing on computer systems. The combination of neural text generation, deterministic term extraction, schema-aligned querying, and feedback-driven prompt tailoring yields improvements in recommendation precision, processing speed, and consistency of dialogue, and enables other practitioners to implement the invention by following the described hardware, software, data structures, and algorithmic flows.

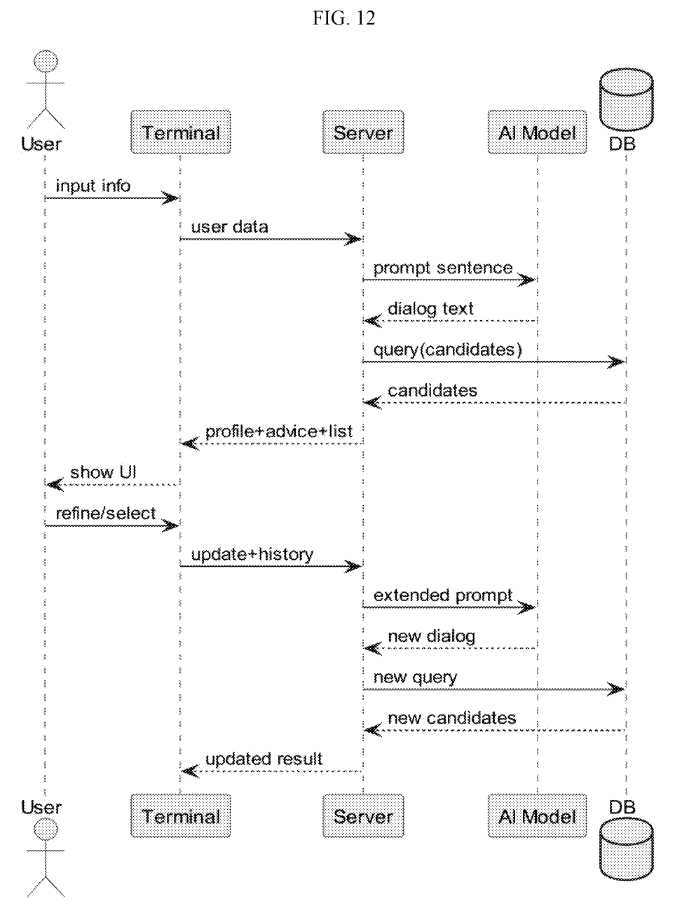

The following describes the processing flow using FIG. 12.

### Step 1

The terminal displays an input interface and acquires initial user information. The terminal receives, as input, user actions on UI components such as text fields, dropdown lists, and buttons. The terminal converts these user actions into attribute information and request content information, such as age, gender, style preference, budget, and free-text request sentences. The terminal stores this information in internal data structures, for example objects or key-value maps, and outputs a structured request payload ready for transmission to the server.

### Step 2

The terminal transmits the structured request payload to the server. The terminal takes, as input, the structured attribute information and request content information generated in Step 1. The terminal serializes this information into a data format such as JSON, encrypts it at the transport layer using a secure communication protocol, and sends it via a network interface to a predefined server endpoint. The terminal outputs an HTTP request message containing the serialized user information as its body.

### Step 3

The server receives and parses the user information. The server takes, as input, the HTTP request message transmitted from the terminal in Step 2. The server decodes the transport protocol, extracts the message body, and parses the serialized JSON into internal data structures such as dictionaries or objects. The server validates field presence and types, normalizes raw values (for example, mapping literal ages to age ranges or mapping free-text style descriptions to controlled style labels), and outputs a normalized structured data record representing the user’s attribute information and request content information.

### Step 4

The server enriches the structured data with derived features. The server takes, as input, the normalized structured data record from Step 3. The server applies text-processing operations to the request content information, such as tokenization, keyword extraction, and pattern matching, to derive additional features like primary product category, potential usage purpose, and implicit constraints (for example, inferred budget from words such as “cheap,” “premium”). The server merges these derived features back into the structured data record and outputs an enriched structured data object containing both the original and the derived information.

### Step 5

The server selects a prompt template and constructs a base prompt sentence. The server takes, as input, the enriched structured data from Step 4. The server evaluates predetermined selection rules, for example if-else conditions based on age range, gender, style preference, and product category, to identify an appropriate template identifier. The server retrieves a corresponding prompt template that contains placeholders for user-specific information. The server then performs string substitution, inserting fields such as age description, gender, style preference, and request text into the template. The server outputs a base prompt sentence in natural language formatted for use with the generative AI model.

### Step 6

The server refines the prompt sentence by incorporating role and personality constraints. The server takes, as input, the base prompt sentence produced in Step 5. The server appends or inserts additional sentences that specify personality information and role information of a virtual dialogue partner character, such as “friendly fashion advisor” or “calm, knowledgeable consultant.” The server may use rule-based logic that maps style preferences and emotional indications to desired tone and speaking manner of the character. The server outputs a final prompt sentence that encodes both user context and explicit instructions for the behavior of the virtual dialogue partner character.

### Step 7

The server tokenizes the prompt sentence and prepares model input for the generative AI model. The server takes, as input, the final prompt sentence from Step 6. The server applies a tokenizer that transforms the prompt sentence into a sequence of token identifiers, and then uses an embedding module to map each token identifier to a vector representation. The server optionally truncates or segments token sequences to satisfy a configured maximum length. The server outputs a tensor or equivalent numerical structure representing the prompt sentence, formatted as input to the generative AI model.

### Step 8

The server invokes the generative AI model and generates dialogue information. The server takes, as input, the numerical representation of the prompt sentence from Step 7. The server feeds this representation through the layers of a neural network-based generative AI model, such as a transformer with multiple attention blocks and feed-forward networks. The server performs matrix multiplications, attention score calculations, non-linear activations, and normalization operations to compute hidden states for each token position. The server then applies a decoding algorithm, such as greedy decoding or sampling-based decoding, to generate a sequence of output tokens representing the model’s response. The server converts the output tokens back into text, and outputs dialogue information including character profile descriptions and advice sentences.

### Step 9

The server segments the dialogue information into profile information and advice information. The server takes, as input, the dialogue text generated in Step 8. The server applies parsing rules, such as section markers, headings, or pattern-based separators, to split the text into distinct portions. The server assigns one portion to profile information, containing personality traits and role descriptions of the virtual dialogue partner character, and another portion to advice information, containing product- or service-related recommendations and explanations. The server outputs a structured dialogue object with at least a profile field and an advice field.

### Step 10

The server extracts attribute terms from the advice information. The server takes, as input, the advice field of the structured dialogue object from Step 9. The server applies lexical analysis and pattern matching algorithms, using dictionaries and regular expressions, to identify and tag terms corresponding to color, category, price range, usage purpose, and optionally other product attributes. The server maps these terms to internal codes or normalized labels defined in a domain ontology. The server outputs a set of attribute terms and associated codes, which are suitable for use in database queries.

### Step 11

The server generates database search conditions based on the attribute terms. The server takes, as input, the set of attribute terms and codes from Step 10 together with previously derived features from Step 4. The server converts each attribute code into query predicates, for example mapping a color code to a color column filter or a price band code to a price interval condition. The server combines multiple predicates into a structured search condition using logical operators such as AND and OR, and ensures that the combined condition conforms to database schema constraints. The server outputs a query object or text string representing search conditions for the product or service database.

### Step 12

The server executes the database query and retrieves candidate information. The server takes, as input, the query object produced in Step 11. The server transmits this query to a database management system using a database driver. The database engine applies indexing and query optimization to fetch records that satisfy the search conditions. The server receives a result set, converts each record into a structured representation, and extracts relevant fields such as product identifier, category, color, price, stock status, and display metadata. The server outputs a list of candidate information entries representing recommendation targets.

### Step 13

The server composes response data for transmission to the terminal. The server takes, as input, the structured dialogue object from Step 9 and the candidate information list from Step 12. The server constructs a response object that includes profile information for the virtual dialogue partner character, advice information text, and the list of recommended candidates. The server may also include metadata such as ranking scores or explanation snippets. The server serializes this response object into a data format suitable for network transmission and outputs a response payload for the terminal.

### Step 14

The terminal receives the response payload and renders the virtual dialogue partner character and recommendations. The terminal takes, as input, the serialized response data sent by the server in Step 13. The terminal deserializes the payload into internal objects, retrieves fields for character profile, advice text, and candidate list, and updates front-end state accordingly. The terminal generates user interface elements, such as a character panel showing name and personality description, a text area displaying advice sentences, and a product listing showing item images, names, and prices. The terminal outputs rendered graphical content on its display for the user to view and interact with.

### Step 15

The user interacts with the rendered character and candidate list. The user takes, as input, the graphical content presented by the terminal in Step 14. The user performs actions such as selecting a candidate item, scrolling through recommendations, or entering a follow-up question into an input field. The user’s actions result in updated inputs for the terminal, such as a clicked product identifier or additional free-text questions. The user effectively outputs interaction signals that the terminal captures as new input events.

### Step 16

The terminal captures interaction events and generates additional input information and dialogue history data. The terminal takes, as input, the user’s interaction signals from Step 15 and the previously received response data. The terminal logs user actions, such as item selections and submitted questions, and constructs dialogue history records that chronicle exchanges between the user and the virtual dialogue partner character. The terminal packages this additional input information and dialogue history information into an updated request payload. The terminal outputs this updated payload, which reflects the continuing context, for communication to the server.

### Step 17

The terminal transmits the updated request payload to the server for continued dialogue. The terminal takes, as input, the updated payload prepared in Step 16. The terminal serializes and encrypts the payload and sends it via the network interface to the server using a secure protocol. The terminal outputs an HTTP request containing additional input information and dialogue history information for the server to process.

### Step 18

The server generates an extended prompt sentence incorporating dialogue history. The server takes, as input, the updated request payload from Step 17. The server parses the payload to separate new user inputs from stored dialogue history. The server selects relevant segments of the dialogue history to maintain contextual coherence while controlling total length. The server concatenates or encodes these segments together with additional input information into an extended prompt template. The server applies string assembly operations to create an extended prompt sentence that summarizes prior exchanges and states updated user requests. The server outputs this extended prompt sentence to be used as input to the generative AI model.

### Step 19

The server repeats generative AI inference and recommendation updating based on the extended prompt sentence. The server takes, as input, the extended prompt sentence from Step 18. The server performs tokenization, embedding, and forward propagation through the generative AI model as in previous inference. The server generates updated dialogue information, re-extracts attribute terms, constructs new database search conditions, queries the database, and obtains revised candidate information. The server then assembles refreshed response data that reflects the user’s additional questions and evolving preferences. The server outputs this refreshed response payload to the terminal, enabling iterative refinement of advice and recommendations.

### Step 20

The server records selection results and purchase processing results as user history information. The server takes, as input, data from the terminal indicating that the user has selected specific candidate items and optionally completed purchase operations. The server stores identifiers of selected items, chosen options such as size and color, timestamps, and transaction outcomes into a user history data structure in the database. The server also links this history to the user’s profile or session identifier. The server outputs updated user history information that can be referenced in future prompt construction and recommendation computations.

### Step 21

The server incorporates user history information into future prompt construction to improve personalization and efficiency. The server takes, as input, the user history information recorded in Step 20 and the structured attribute information from subsequent sessions. The server analyzes historical selection patterns, such as repeated preference for certain colors or price ranges, using statistical methods or rule-based thresholds. The server modifies the base prompt template and its parameters to encode these recurring preferences, for example by specifying them as default assumptions for the virtual dialogue partner character. The server thereby generates prompt sentences that require fewer tokens to re-establish context and that guide the generative AI model toward more accurate and efficient recommendations. The server outputs these history-aware prompt sentences, which form the starting point for new inference cycles.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional dialogue systems that utilize natural language processing and generative artificial intelligence models typically operate as passive responders that output generic replies in response to explicit user input. Such systems generally lack fine-grained, machine-implemented control over (i) how and when a dialogue is initiated based on user context, (ii) how dialogue history and user attributes are encoded into a prompt sentence for a generative AI model, and (iii) how the generative AI model is constrained to produce context-appropriate and safety-aware output, particularly for minors staying alone in a residential environment. As a result, known systems can suffer from several technical drawbacks: excessive or untimely network calls to AI services, inefficient use of computational resources in the server, unstable or inconsistent dialogue quality due to ad hoc prompt construction, and difficulty in ensuring that generated dialogue maintains a reassuring tone suitable for vulnerable users.

Further, many existing systems treat sensor data, user environment information, and dialogue history as loosely coupled data streams, without providing a unified, processor-implemented pipeline that transforms heterogeneous input (sensor data, user responses) into a structured control signal for a generative AI model. This separation can cause latency, redundant processing, and increased memory access overhead, since the system must repeatedly re-derive user context for each dialogue turn rather than maintaining an integrated dialogue state. In addition, there is no standardized mechanism for dynamically deciding, in the processor, whether to continue or suspend a dialogue session based on real-time situation detection and accumulated interaction history.

Moreover, typical generative AI based systems do not implement, at the system level, explicit constraint embedding into prompt sentences, such as specifying that the addressee is a minor and that the tone must provide a sense of security. Instead, they rely on static model configuration or manual prompt engineering, which is not robust or scalable when running on a server that simultaneously serves many users with differing profiles and contexts. This can result in technically undesirable behaviors including inconsistent safety enforcement, unpredictable output variations, and increased need for post-generation filtering, which in turn increases server load and response latency.

Accordingly, there is a need for a computer-implemented system that improves the operation of a server by (1) automatically detecting user situations from environment information and user input, (2) generating structured prompt sentences that integrate situation, dialogue history, user attributes, and safety constraints, (3) controlling invocation of a generative AI model and its dialogue generation based on a determination of dialogue continuity and timing, and (4) doing so in a manner that reduces redundant computation, improves responsiveness, and provides stable, context-appropriate, and safety-aware dialogue for users such as minors staying alone.

The specific processing by the specific processing unit 290 of the data processing device 12 in Example 2 is realized by the following means.

The present invention provides a server comprising a processor configured to acquire user environment information and user input information from at least one terminal device or sensor device so as to detect a situation of a user; to generate a prompt sentence by constructing a generative input text based on the detected situation of the user and stored past dialogue history, the generative input text including attribute information and interest information of the user and constraint information indicating that a dialogue sentence is for a minor and that a tone of the dialogue sentence provides a sense of security; to input the prompt sentence to a generative artificial intelligence model and cause the generative artificial intelligence model to perform computation so as to generate a dialogue sentence adapted to the situation and an emotional state of the user; to transmit the generated dialogue sentence to the terminal device and cause the terminal device to present the generated dialogue sentence to the user by at least one of a voice output unit and a display output unit; to convert a response of the user, acquired from the terminal device, into character information, to store the character information as part of the dialogue history, and to reuse the stored dialogue history for subsequent generation of the prompt sentence; and to determine, based on the detected situation of the user and the stored dialogue history, whether to continue a dialogue and a timing to start the dialogue, and to control the generation of the prompt sentence and the generation of the dialogue sentence by the generative artificial intelligence model according to a result of the determination. This enables an improvement in computer functionality by providing a unified, processor-implemented control flow that dynamically integrates environment detection, dialogue state management, structured prompt construction, and constrained generative AI invocation, thereby reducing redundant processing and latency on the server, stabilizing dialogue quality, and reliably producing context-appropriate, safety-aware dialogue for users such as minors staying alone in a residential environment.

The term “user environment information” refers to data indicating a condition of a physical or virtual environment around a user, including at least one of sensor detection data, device status data, location-related data, or time-related data, which is acquired from a terminal device or a sensor device.

The term “user input information” refers to data that directly represents an input operation or expression by a user, including at least one of voice data, text data, touch input data, or selection input data, which is acquired via a terminal device.

The term “situation of a user” refers to a state of the user inferred by a processor based on user environment information and user input information, including at least one of a presence state, an activity state, an isolation state, or an emotional tendency of the user.

The term “dialogue history” refers to a collection of stored records representing past exchanges between a user and a dialogue system, including at least user utterances and system-generated dialogue sentences, which is used as contextual information for subsequent processing.

The term “generative input text” refers to a text sequence constructed by a processor based on at least the situation of a user, dialogue history, and user-related information, the text sequence being configured as input to a generative artificial intelligence model.

The term “prompt sentence” refers to a text expression that includes at least part of a generative input text and optionally constraint information, and that is supplied to a generative artificial intelligence model as an instruction or context to cause generation of a dialogue sentence.

The term “generative artificial intelligence model” refers to a machine-learned model that performs probabilistic generation of text or tokens based on an input sequence, by executing numerical computation on a processor or an accelerator, and that outputs at least one dialogue sentence in response to a prompt sentence.

The term “dialogue sentence” refers to a natural-language text generated by a generative artificial intelligence model in response to a prompt sentence, the text being intended to be presented to a user as part of an interactive dialogue.

The term “terminal device” refers to an information processing apparatus that is capable of communicating with a server, acquiring user input information, and presenting dialogue sentences to a user, including at least one of a mobile information terminal, a stationary information terminal, or a home appliance having communication functionality.

The term “voice output unit” refers to a hardware and software combination that converts text information into an audio signal and outputs the audio signal through a sound-emitting component, thereby presenting information to a user by sound.

The term “display output unit” refers to a hardware and software combination that visually presents text, images, or icons on a display surface, thereby presenting information to a user by sight.

The term “character information” refers to data representing a sequence of characters or symbols obtained by converting user speech or other input into text form, which is suitable for storage, search, and further text-based processing.

The term “sensor device” refers to an apparatus that detects a physical quantity or event in an environment and outputs corresponding detection data, including at least one of a motion sensor, a contact sensor, an image sensor, or an acoustic sensor.

The term “residential space” refers to a living space such as a dwelling or a room in which a user ordinarily spends daily life, and in which the presence or absence of a guardian can be determined based on environment information.

The term “guardian” refers to an adult person who has at least partial responsibility for supervision or protection of a user, including at least a parent or a legal custodian, whose presence or absence in a residential space is evaluated by the system.

The term “attribute information of the user” refers to data indicating inherent or relatively stable properties of a user, including at least one of an age range, a role, or a language preference of the user.

The term “interest information of the user” refers to data indicating preferences or favored topics of a user, including at least one of preferred activities, hobbies, or content types, which is used to personalize a dialogue sentence.

The term “constraint information” refers to data embedded in or associated with a generative input text or a prompt sentence, the data specifying at least one restriction or condition on a dialogue sentence to be generated by a generative artificial intelligence model, such as an intended addressee or a required tone.

The term “tone of the dialogue sentence” refers to a stylistic characteristic or manner of expression of a dialogue sentence, including at least one of friendliness, calmness, politeness, or reassurance, which is controlled using constraint information.

The term “emotional state of the user” refers to a state indicating at least one of a mood, affect, or attitude of the user, which is inferred by a processor based on user input information or dialogue history.

The term “dialogue continuity” refers to a condition indicating whether a dialogue between a user and a system is to be continued or suspended, as determined by a processor based on at least the situation of the user and the dialogue history.

The term “timing to start the dialogue” refers to a time point or time interval at which a processor determines that initiation or re-initiation of a dialogue with a user is appropriate, based on at least user environment information and the dialogue history.

In one embodiment, a server, a terminal, and a user cooperate to realize a dialogue system that generates and presents context-sensitive prompt sentences and dialogue sentences using a generative AI model. The server includes at least one processor, a memory, a network interface, and a non-transitory storage medium. The terminal includes at least one processor, a memory, a display output unit and/or a voice output unit, an input unit, a microphone, and a network interface. The user operates the terminal and stays in a residential space in which at least part of the environment is monitored by one or more sensor devices.

The server executes a program stored in the non-transitory storage medium. The program is implemented, for example, on a general-purpose operating system and an application framework written in a high-level programming language such as Python, Java, or JavaScript. The server uses a database management system such as a relational database or a document-oriented database to store user environment information, user input information, dialogue history, attribute information, and interest information. The server further uses a generative AI model implemented as a neural network model, for example a transformer-based language model, deployed on one or more accelerators such as graphics processing units.

The server acquires user environment information and user input information through the network interface. The server receives environment information from a terminal and/or a sensor device. The sensor device includes at least one of a motion detection unit, a door open/close detection unit, an image capture unit, or a sound level detection unit. The terminal acquires raw sensor signals through hardware drivers and converts the signals into digital detection data. The terminal encapsulates the detection data into structured messages, for example including fields such as a device identifier, a sensor type, a detection value, and a timestamp, and transmits the messages to the server using a communication protocol such as HTTP or a message-oriented protocol.

The server stores the received detection data in a data structure such as a time-series table. The server performs data normalization by mapping different sensor types into a unified feature vector. The server uses a feature extraction module to generate environment feature values such as presence probability, noise level category, time-of-day category, and household occupancy estimate. The server derives a “situation of the user” variable by applying a rule-based decision mechanism and/or a trained classifier. In one example, the server uses a decision tree classifier trained on historical labeled data to infer whether the user is staying alone in a residential space in which a guardian is absent. The classifier uses features such as the number of detected mobile devices, motion patterns across rooms, and calendar information. The server records the inferred situation as a structured record containing fields such as isolation_state, activity_state, and context_confidence.

The server also acquires user input information from the terminal. The terminal captures user speech via a microphone and user text via a keyboard or touch interface. When the user speaks, the terminal uses automatic speech recognition software executed locally or in a remote speech recognition service. The speech recognition software converts audio frames into acoustic feature vectors, applies a neural network acoustic model and a language model, and decodes a text sequence representing the user utterance. The terminal transmits the text sequence, along with metadata such as a language code and a recognition confidence score, to the server.

The server stores each user utterance as a dialogue history record. Each record includes at least a speaker identifier, a text content field, a timestamp, and a situation snapshot at the time of utterance. The server maintains a dialogue history table indexed by user identifiers and time. The server uses this dialogue history to construct a generative input text for the generative AI model.

The server generates a generative input text by concatenating several components in a predetermined order. The server includes system-level instructions, user attribute information, user interest information, situation descriptors, and recent dialogue turns. For example, the server constructs an input as follows:

System: You are a friendly AI companion for a child who is currently at home alone.

Constraints: Speak in simple, reassuring language. Do not mention dangerous or frightening topics.

User attributes: Age range: 8–10. Preferred activities: drawing, cartoons, animals.

Situation: The child is staying alone in a residential space after school.

Dialogue history:

Child: I want to draw a picture today.

Assistant: What kind of pictures do you like to draw?

Child: I like drawing animals.

Instruction: Generate the next one-sentence message that encourages the child to enjoy drawing animals and provides a sense of security.

This text constitutes an example of the prompt sentence used as input to the generative AI model. The server may modify the wording of the prompt sentence depending on the detected situation and the dialogue state. For example, in a study support scenario, the server may generate a prompt sentence such as:

System: You are helping a child who is doing homework alone at home.

Constraints: Use very clear and simple explanations. Guide step by step without giving the full answer immediately.

User attributes: Age range: 10–12. Preferred activity: mathematics.

Situation: The child is staying alone in a residential space in the evening.

Dialogue history:

Child: I don’t understand this math problem.

Problem: If you have 3 apples and you buy 2 more apples, how many apples do you have in total?

Instruction: Generate one friendly question that helps the child start solving this problem.

The server provides the constructed prompt sentence to the generative AI model. The generative AI model is implemented as a transformer neural network having multiple self-attention layers, feed-forward layers, and embedding layers. The model parameters include, for example, word embedding matrices, positional encoding parameters, layer normalization parameters, and weight matrices for attention and feed-forward projections. The model has been trained in advance on a large corpus of text using a language modeling objective, for example minimizing a cross-entropy loss between predicted token distributions and ground-truth next tokens.

In one training method, the model uses backpropagation to compute gradients of the loss function with respect to each weight. The server or an external training environment updates the weights using a stochastic gradient descent algorithm or a variant such as Adam optimization. The training data may be augmented by techniques such as random masking, paraphrase generation, and domain-specific fine-tuning to specialize the model for child-safe, supportive dialogue. The model may be further fine-tuned on curated dialogue examples that specify appropriate tone and safety constraints.

At inference time, the server tokenizes the prompt sentence into a sequence of token identifiers. The server supplies the sequence to the generative AI model executed on an accelerator. The model performs a series of matrix multiplications, nonlinear activations, and attention weight calculations to produce a probability distribution over possible next tokens at each time step. The server selects the next token according to a decoding algorithm such as greedy search, beam search, or top-k sampling with temperature adjustment. The server repeats this process until a termination condition is reached, such as generation of an end-of-sentence token or a maximum length.

The server obtains the generated tokens and detokenizes them into a dialogue sentence. The server applies a safety filter that evaluates the generated sentence against rule-based patterns and trained classification models. The safety filter checks that the sentence does not contain disallowed topics and that the tone remains within a desired emotional range. If the sentence does not satisfy the constraints, the server may regenerate the sentence with adjusted model parameters, such as lower temperature or restricted vocabulary, or may replace the output with a fallback sentence.

The server transmits the final dialogue sentence to the terminal. The terminal receives the dialogue sentence and, depending on its capabilities, either displays the text via a display output unit or converts the text to speech via a voice output unit. For text display, the terminal renders the sentence in a dialogue bubble or a similar interface, optionally along with icons or animations. For voice output, the terminal invokes a text-to-speech engine, which converts the text into a digital audio signal using a synthesis model such as a concatenative synthesizer or a neural vocoder. The terminal plays the audio through a speaker, enabling the user to hear the generated dialogue sentence.

The user responds to the dialogue sentence. For example, in the drawing scenario, the user may say, “I want to draw a big blue dragon,” or “I want to start with the head.” The terminal captures the response and converts it into text using speech recognition. The terminal transmits the text to the server. The server appends the new user utterance to the dialogue history and updates the situation state, including an estimated emotional state such as excited, calm, or anxious. The server then constructs a new prompt sentence including the updated context and repeats the generation and presentation process.

The server determines whether to continue or suspend the dialogue based on the situation of the user and the dialogue history. The server maintains a dialogue state variable that represents whether the dialogue is active, idle, or terminated. The server updates the dialogue state using criteria such as elapsed time since the last user response, number of unanswered system prompts, and current activity inferred from sensor data. For example, if the user has been silent for a period longer than a threshold and motion sensors indicate that the user left the room, the server may set the dialogue state to idle and stop sending new prompt sentences. If the sensors later detect that the user has returned and is again alone, the server may generate an initial prompt sentence such as “Welcome back. Do you want to continue drawing or try something else?” This dynamic control reduces unnecessary network traffic and computational load by avoiding superfluous calls to the generative AI model when the user is not present or not engaged.

The described structure improves computer technology in several ways. The server maintains an integrated state that combines environment information, user input information, and dialogue history in a compact data structure. This integrated state allows the server to avoid recomputing the situation for every single request from scratch, reducing redundant feature extraction. The server uses a structured prompt construction pipeline, in which user attributes, interests, and constraints are embedded explicitly into the generative input text. This structure stabilizes the behavior of the generative AI model because the model receives consistently formatted, context-rich prompts, reducing the variance in generated outputs and decreasing the need for expensive post-processing.

The server further improves computational efficiency by selecting the timing of generative AI model invocation based on a determination of dialogue continuity. By suppressing model calls when the dialogue is inactive, the server reduces accelerator utilization, network bandwidth consumption, and database access frequency. At the same time, the server maintains responsiveness by immediately invoking the model when the situation detection indicates that the user is again alone and likely to need support. Because the decision logic uses a combination of sensor-based features and dialogue-based features, the system uses non-obvious, machine-specific criteria that differ from simple user-initiated chat triggers.

The generative AI model itself is not used as a generic text generator; rather, the server constrains the model via explicit constraint information in the prompt sentence. In particular, the server specifies that the dialogue is for a minor and must provide a sense of security. This explicit control, coupled with a safety filter, reduces the frequency of undesirable outputs and thereby reduces the need for manual intervention or repeated regeneration. In some embodiments, the server maintains multiple sub-models or sub-prompts specialized for different age ranges or activity types, and selects among them algorithmically based on attribute information and interest information. This selection mechanism, implemented on the server, further contributes to reduction of computation by avoiding the use of unnecessarily complex prompts for simple interactions.

The system uses non-conventional data structures and flows. For example, the server stores dialogue history as a sequence of typed turns, each turn carrying both text and a contemporaneous snapshot of situation features. This combined storage allows the server to reconstruct not only what was said but also in which environmental context it was said, which in turn enables more precise situation-based prompting. When the server builds the generative input text, the server can include only those context fields that are statistically correlated with output quality, thereby reducing prompt length and transmission time. This design improves latency and throughput compared to systems that transmit large volumes of unstructured context at each turn.

The server can be implemented in various configurations. In one variation, the generative AI model executes entirely on a separate AI computation node, and the server communicates with the node through an internal network protocol. In another variation, the terminal contains a lightweight local generative model, and the server sends compressed context vectors rather than full prompt sentences, thereby further reducing network load. In yet another embodiment, the situation detection module resides partially on the terminal, which performs preliminary filtering of sensor data before sending it to the server, reducing noise and irrelevant data.

The terminal can also vary. A terminal may be a mobile information terminal such as a smartphone or tablet, a stationary information terminal such as a smart display, or an embedded controller in a home appliance. In each case, the terminal implements similar functional roles: acquisition of sensor data, capture of user input, presentation of dialogue sentences, and communication with the server. The specific hardware, such as the display technology or the microphone sensitivity, may differ, but the logical behavior is consistent.

The user can use the system in different scenarios. In a creative support scenario, the user may interact with the system to draw pictures, compose stories, or play imagination games. The system generates prompt sentences such as “What kind of animal do you want to draw today?” or “Shall we imagine a story about your favorite character?” In a study support scenario, the system generates prompt sentences such as “Which part of the problem is difficult for you?” or “Can you read the question aloud to me?” The same underlying mechanism of environment detection, dialogue history integration, and constrained generative output is used in each scenario, but with different constraint information and interest information embedded in the prompt sentence.

By integrating these components into a single, coherent system, the server, the terminal, and the user together realize a technical solution that is more than a mere automation of human conversation. The server implements specific algorithms for situation detection, dialogue state management, prompt construction, and generative model invocation that improve processing speed, reduce unnecessary computation, and enhance the consistency and safety of generated dialogue. This architecture allows the system to operate efficiently on real-world hardware, to manage sensor and dialogue data in a structured manner, and to provide a concrete technical improvement in the field of computer-implemented dialogue systems utilizing a generative AI model.

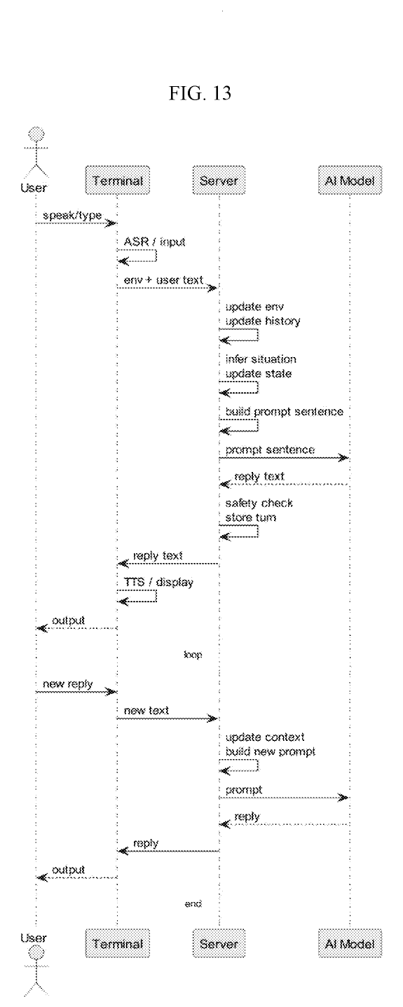

The following describes the processing flow using FIG. 13.

### Step 1

The terminal acquires environment information.

The terminal uses built-in hardware modules such as a motion sensor, a microphone, and a screen-activity monitor, and optionally external sensor devices, to collect raw environment signals.

Input: raw sensor readings (for example, motion on/off, sound level, device active/inactive, time information).

The terminal converts the raw readings into digital detection data, attaches metadata such as a terminal identifier and a timestamp, and serializes the data into a structured message. The terminal encapsulates the structured message in a network request and transmits it to the server via a communication protocol.

Output: structured environment message sent to the server.

### Step 2

The server normalizes and stores the environment information.

The server receives the environment message through a network interface and passes it to a parsing module.

Input: structured environment message from the terminal.

The server parses the message, validates required fields, and maps each sensor type to a canonical internal representation. The server writes normalized records into a time-series table in a database, associating each record with a user identifier and a timestamp. The server also aggregates recent records into a feature vector that includes values such as recent motion frequency, noise level category, and device-activity pattern.

Output: normalized environment records and an environment feature vector stored in the database.

### Step 3

The terminal acquires user input information.

The terminal prompts the user to interact by displaying or speaking a question or greeting, and the user responds.

Input: user speech captured by a microphone and/or text entered via a keyboard or touch interface.

The terminal, when voice input is used, segments the audio into frames, sends the frames to a speech recognition module, and receives a recognized text string. When text input is used, the terminal directly retrieves the character sequence from the user interface. The terminal adds metadata such as language code, recognition confidence, and timestamp, and constructs a user-input message.

Output: user-input message containing user text and metadata sent to the server.

### Step 4

The server updates dialogue history with the user input.

The server receives the user-input message and forwards it to a dialogue-management module.

Input: user-input message containing recognized text and metadata.

The server creates a dialogue-turn record that includes a speaker identifier, the text content, the timestamp, and a snapshot of current environment features. The server inserts the dialogue-turn record into a dialogue history table indexed by user identifier and time. The server may compute a basic sentiment score or emotional tendency from the text using a text-analysis routine and store it together with the record.

Output: updated dialogue history stored in the database.

### Step 5

The server infers the situation of the user.

The server accesses recent environment feature vectors and recent dialogue records for the same user.

Input: environment feature vector and latest dialogue history records for the user.

The server runs a situation-inference algorithm, which may include rule-based logic and a trained classifier, to determine whether the user is alone in a residential space and what activity state the user is likely in. The server, for example, evaluates conditions such as absence of guardian devices, exclusive motion in a child’s room, and time-of-day within a defined after-school interval. The server combines these features using a decision function to produce a situation label (for example, “home_alone_after_school”, “studying”, “playing”). The server stores this situation label and an associated confidence score in a status table.

Output: situation record for the user, including a situation label and confidence score.

### Step 6

The server determines dialogue state and timing.

The server reads the situation record and the dialogue history to update dialogue state.

Input: situation record and latest dialogue-turn timestamps.

The server compares the time elapsed since the last user utterance with predetermined thresholds, and checks whether the situation label indicates that the user is alone and available. The server updates a dialogue-state variable (for example, “inactive”, “active”, “idle”). If the user is detected to be newly alone and the dialogue state is inactive, the server marks the dialogue state as active and schedules immediate generation of a new prompt sentence. If the user has been inactive beyond a timeout while no user presence is detected, the server sets the dialogue state to idle and suppresses new generation.

Output: updated dialogue-state variable and a control signal indicating whether prompt generation should occur.

### Step 7

The server selects dialogue context for prompt construction.

The server prepares context information for the generative input text when prompt generation is required.

Input: dialogue history, situation record, user attribute information, and user interest information.

The server selects a subset of recent dialogue turns, for example the latest ten user and system messages, and extracts key elements such as the last user request and prior topics. The server retrieves stored user attributes (for example, age range, language preference) and interest tags (for example, drawing, mathematics, animals). The server also retrieves the latest situation label and any stored emotional tendency. The server composes a context structure that orders these items according to a fixed scheme, such as system instructions, constraints, user attributes, situation description, and recent dialogue excerpts.

Output: context structure including ordered elements for generative input text.

### Step 8

The server constructs the prompt sentence.

The server converts the context structure into a natural-language prompt sentence suitable for the generative AI model.

Input: context structure containing system instructions, constraints, user attributes, situation description, and selected dialogue history.

The server applies a template-based generator that concatenates static phrases and variable content. The server inserts user-specific data and situation descriptors into predefined slots, while preserving instruction and constraint phrases. For example, the server may produce a prompt sentence such as:

“You are a friendly AI companion for a child who is currently at home alone. Speak in simple, reassuring language. Do not mention dangerous or frightening topics. The child is 8–10 years old and likes drawing and animals. The child said: ‘I want to draw a picture today.’ You replied: ‘What kind of pictures do you like to draw?’ The child said: ‘I like drawing animals.’ Generate the next one-sentence message that encourages the child to enjoy drawing animals and provides a sense of security.”

The server ensures that the resulting text satisfies length constraints and includes all required constraint information.

Output: finalized prompt sentence to be provided to the generative AI model.

### Step 9

The server invokes the generative AI model.

The server prepares a model-input object for a transformer-based generative AI model.

Input: prompt sentence and model parameters such as maximum token length and temperature.

The server tokenizes the prompt sentence into a sequence of token identifiers and passes the sequence and parameters to the generative AI model running on an accelerator. The model computes embeddings, applies multiple self-attention layers and feed-forward layers, and produces probability distributions over possible next tokens at each decoding step. The server uses a decoding algorithm, such as top-k sampling with temperature scaling, to select specific tokens from the distributions and form a generated token sequence. The server terminates decoding when reaching an end-of-sentence condition or a length limit, and converts the token sequence back into a text string.

Output: generated dialogue sentence text returned from the generative AI model.

### Step 10

The server validates and records the generated dialogue sentence.

The server checks the generated dialogue sentence for safety and consistency.

Input: generated dialogue sentence text and constraint information used in the prompt sentence.

The server passes the dialogue sentence through a safety-evaluation module that applies rule-based filters and optional classification models to detect prohibited topics or inappropriate language. If the sentence fails the evaluation, the server may adjust model parameters and regenerate or replace the sentence with a safe fallback. If the sentence passes, the server creates a dialogue-turn record for the system side, including the text, timestamp, situation snapshot, and references to the prompt sentence and model configuration. The server stores this record in the dialogue history table.

Output: validated dialogue sentence stored in dialogue history and marked as ready for delivery.

### Step 11

The server transmits the dialogue sentence to the terminal.

The server packages the validated dialogue sentence for presentation.

Input: validated dialogue sentence and presentation preferences (for example, voice, text, or both).

The server creates a response message including the dialogue text and metadata indicating output mode. The server sends the message to the terminal via the network interface. In some configurations, the server compresses the message or batches multiple messages to reduce network overhead.

Output: response message containing the dialogue sentence delivered to the terminal.

### Step 12

The terminal presents the dialogue sentence to the user.

The terminal receives the response message and selects an output mode.

Input: response message including dialogue text and output mode instruction.

The terminal, for text output, renders the text using a graphical user interface, for example as a chat bubble or banner. For voice output, the terminal passes the text to a text-to-speech engine, which generates an audio waveform. The terminal plays the audio waveform through a speaker. The terminal may also display accompanying visual cues, such as an avatar or icon, synchronized with the audio playback.

Output: presented dialogue sentence perceived by the user as text and/or voice.

### Step 13

The user responds to the dialogue sentence.

The user hears or reads the dialogue sentence and provides a new response.

Input: dialogue sentence presented via display or speaker.

The user either speaks a reply (for example, “I want to start with the dragon’s head”) or types a message (for example, “I don’t understand this part of the homework”). The terminal captures the response via the microphone or input interface.

Output: new raw user response captured by the terminal.

### Step 14

The terminal converts the user response into text and sends it to the server.

The terminal processes the newly captured user response.

Input: raw audio signal of user speech and/or raw text input.

For speech, the terminal segments the audio, extracts acoustic features, and sends them to a speech recognition component, which outputs a recognized text string. For typed input, the terminal directly obtains the string from the input control. The terminal attaches metadata, including timestamp, language code, and possible recognition confidence, and constructs a new user-input message. The terminal sends this message to the server, where it will serve as the next input for dialogue history updating and situation inference.

Output: user-input message for the next cycle of processing on the server.

### Step 15

The server repeats the cycle with updated context.

The server treats the new user-input message as a trigger for the next iteration of situation inference and dialogue generation.

Input: latest user-input message, updated environment records, and existing dialogue history.

The server updates the dialogue history, recomputes the situation record if necessary, re-evaluates the dialogue state, and, when appropriate, constructs a new context structure and prompt sentence. The server then calls the generative AI model again to obtain a new dialogue sentence. This iterative cycle continues as long as the dialogue state remains active, thereby maintaining a context-aware, safety-constrained conversational experience.

Output: ongoing sequence of generated dialogue sentences and updated dialogue state maintained on the server.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional dialogue systems and recommendation systems typically apply fixed rule sets or simple sentiment scores to generate responses to user inputs. Such systems suffer from several technical deficiencies. First, processing pipelines often keep only shallow or fragmented context, so that prompt sentences sent to a generative AI model do not accurately encode multi‑turn history, user attributes, and real‑time emotion, resulting in unstable and inconsistent outputs. Second, input preprocessing usually treats text, audio, location, and visual data independently, without a unified mechanism for fusing these heterogeneous signals into a single, machine‑interpretable representation. This leads to poor utilization of available sensor data and prevents accurate detection of user situations, such as whether the user is at home, in a store, or in another environment. Third, existing arrangements typically pass raw or minimally processed user text directly to a generative model, leaving the model to infer context and intent on its own. This causes unpredictable latency, increased processing load inside the model, and degraded response quality, because the generative model must internally re‑solve problems that could be structured and constrained outside the model.

Furthermore, conventional architectures generally lack a control layer that dynamically adapts prompt construction based on changes in detected user emotion and context. As a result, the system cannot automatically adjust dialogue policies or response strategies over time in a technically robust way. For example, when a user transitions from high stress to a more neutral state, or moves from one part of a physical store to another, many systems do not systematically update the internal dialogue policy, and instead continue to generate responses based on outdated assumptions. This results in inefficient use of computation, redundant calls to external services, and inconsistent user experience.

Therefore, there is a need for a computer‑implemented technique that improves how user input is processed, how emotion and situation are detected and fused, and how structured prompt sentences are generated and updated for a generative AI model. The technical problem addressed by the present invention is to provide a processing architecture in which a processor performs coordinated natural language processing, multimodal analysis, context classification, and prompt generation so that the generative AI model receives constrained, context‑rich input. This improves the determinism, efficiency, and quality of the generated dialogue at the system level, rather than merely changing the behavior of the model itself.

The specific processing by the specific processing unit 290 of the data processing device 12 in Application Example 2 is realized by the following means.

The present invention provides a server comprising a processor configured to acquire input information from a user via one or more terminal devices and to perform, on the input information, linguistic and acoustic analysis using a natural language processing technique and a voice processing technique, to identify, based on results of the analysis, an emotional state of the user and situation information including position information by invoking an emotion analysis processing unit and a situation analysis processing unit, and to determine a dialogue policy and a response policy in accordance with the emotional state and the situation information, to generate a structured prompt sentence for input to a generative information processing model on the basis of the emotional state, the situation information, the dialogue policy, the response policy, user attribute information, and past dialogue history, to transmit the prompt sentence as an input query to the generative information processing model and to receive, from the generative information processing model, a dialogue sentence or a response sentence adapted to the emotional state and the situation information of the user, to provide the dialogue sentence or the response sentence to the terminal device for presentation to the user or to a dialogue staff member, and to record new input information from the user and the provided dialogue sentence or response sentence as dialogue history and, based on the dialogue history, to update the prompt sentence so as to continue multi‑turn dialogue. This enables the server to offload context management and multimodal fusion from the generative information processing model into a dedicated control layer that constructs optimized prompt sentences, thereby improving computational efficiency, stabilizing response behavior across turns, and enhancing the technical performance of emotion‑aware, situation‑adaptive dialogue generation in a computer‑implemented environment.

The term “processor” refers to a hardware information processing unit, such as a central processing unit or an execution core, that executes program instructions to perform analysis, determination, generation, transmission, and recording operations described in the system.

The term “input information” refers to digital data received from a user, including at least one of character information, voice information, image information, position information, and device‑related metadata.

The term “character information” refers to text data expressed in a natural language, including user‑entered sentences, words, symbols, and any text obtained by converting voice information into text.

The term “voice information” refers to audio data representing spoken utterances of a user, including raw audio signals and acoustic features derived from the audio signals.

The term “natural language processing technique” refers to a computational method for analyzing text data, including at least one of tokenization, morphological analysis, part‑of‑speech tagging, syntactic parsing, entity extraction, and intent detection.

The term “voice processing technique” refers to a computational method for analyzing audio data, including at least one of speech recognition, prosody analysis, feature extraction, and acoustic pattern analysis.

The term “emotion analysis processing unit” refers to a software or hardware component configured to compute an emotional state of a user from input information by applying at least one of sentiment analysis, tone analysis, or expression analysis.

The term “situation analysis processing unit” refers to a software or hardware component configured to determine situation information of a user by analyzing at least one of position information, environment information, device information, and interaction patterns.

The term “emotional state” refers to a classification or parameterization of a user’s affective condition, including categories such as joy, sadness, anger, anxiety, fatigue, or neutrality, and optionally including intensity values.

The term “situation information” refers to contextual data describing a user’s usage condition, including at least one of position information, environment information, time information, and identified usage scenario.

The term “position information” refers to data indicating a physical or virtual location associated with a user or a terminal device, including at least one of geographic coordinates, region identifiers, indoor area identifiers, and virtual space identifiers.

The term “environment information” refers to contextual information related to a surrounding environment of a user, including at least one of device type, sensor readings, network identifiers, and store‑layout identifiers.

The term “dialogue policy” refers to a set of control parameters and rules specifying a target style, tone, length, content focus, and progression strategy for system‑generated dialogue in view of an identified emotional state and situation information.

The term “response policy” refers to a set of control parameters and rules specifying how and what type of response should be produced, including at least one of comfort, guidance, recommendation, small talk, or escalation.

The term “user attribute information” refers to static or semi‑static data describing a user, including at least one of age group, gender type, preference, interest, and category of concerns.

The term “past dialogue history” refers to stored records of prior interactions between the user and the system, including at least user inputs, system outputs, associated emotional states, and context annotations.

The term “prompt sentence” refers to a structured natural language instruction or query generated by the processor and supplied to a generative information processing model to condition and constrain generation of a dialogue sentence or a response sentence.

The term “generative information processing model” refers to a parameterized computational model configured to generate text data in a natural language in response to an input prompt sentence, based on learned statistical relationships or patterns.

The term “dialogue sentence” refers to a text output generated by the generative information processing model and intended to be used as a conversational utterance toward a user.

The term “response sentence” refers to a text output generated by the generative information processing model and intended to be used as a reply that includes at least one of guidance, recommendation, explanation, or support.

The term “terminal device” refers to a user‑side electronic apparatus, including at least one of a mobile communication device, a wearable device, or a computing device, which acquires user information and presents system outputs.

The term “dialogue staff member” refers to a human operator or attendant who performs dialogue with a user by referring to system‑generated guidance or phrases.

The term “dialogue history” refers to an accumulated set of interaction records including new input information from the user and generated dialogue sentences or response sentences, which is used to update prompt sentences for subsequent turns.

The term “multi‑turn dialogue” refers to an interaction mode in which a sequence of two or more user inputs and system outputs are linked through shared context so that later outputs depend on earlier turns.

The term “consultation content information” refers to information describing a subject of consultation requested by a user, including at least one of problem type, topic description, and conversational goal.

The term “consultation partner character” refers to a virtual persona defined by character setting information and speech style information, which is used as a consistent dialogue role toward a user.

The term “character setting information” refers to parameters defining attributes of a virtual persona, including at least one of apparent age group, personality type, expertise area, and relational role.

The term “speech style information” refers to parameters defining how a virtual persona speaks, including at least one of tone, formality level, vocabulary selection, sentence length, and interaction pattern.

The term “usage situation” refers to a classification of a user’s operational context in a space, including at least one of a store space, a living space, and a virtual space.

The term “store space” refers to a physical or virtual environment in which goods or services are provided to customers.

The term “living space” refers to a physical or virtual environment associated with a residence or daily life activities of a user.

The term “virtual space” refers to a computer‑generated environment, including at least one of an online service space, a virtual reality space, and a mixed reality space.

The term “proposal sentence” refers to a generated text that recommends at least one of a product, a service, an action, or a content item to a user.

The term “psychological support sentence” refers to a generated text that is intended to provide emotional support, reassurance, or encouragement to a user based on an emotional state.

The term “small‑talk sentence” refers to a generated text that is intended to maintain light or casual conversation without focusing on task‑oriented guidance or recommendation.

In one embodiment, a server cooperates with one or more terminals to implement the claimed system. The server includes at least one hardware processor, a volatile memory, a non‑volatile storage device, and a network interface. The terminal includes at least one hardware processor, a memory, a display, an audio input/output unit such as a microphone and a speaker, an image capture unit such as a camera, and a communication interface. The terminal may be implemented as a mobile communication device, a wearable device such as smart glasses, or a general‑purpose computing device.

The server executes an operating system such as a general‑purpose server operating system and executes application software implementing modules corresponding to a natural language processing technique, a voice processing technique, an emotion analysis processing unit, a situation analysis processing unit, and a generative information processing model interface. The server stores program instructions and configuration data in the storage device and loads the instructions into the memory for execution by the processor.

The terminal executes an operating system such as a mobile operating system and a client application. The terminal acquires input information from a user by means of a touch screen, a keyboard, a microphone, and a camera. The terminal converts raw sensor values into digital data structures and transmits the data structures to the server via a packet‑based communication protocol such as HTTPS over TCP/IP.

The server uses a natural language processing library, for example a library implementing tokenization, part‑of‑speech tagging, dependency parsing, and named entity recognition, to process character information contained in input information. The server also uses a voice processing component, for example a speech‑to‑text engine and a prosody analysis algorithm, to process voice information. The server converts voice information into text by applying an acoustic model and a language model and extracts acoustic features such as pitch, energy, and speaking rate over fixed‑length frames. The server stores the extracted text and acoustic features as entries in a relational data structure, for example a table with fields including session identifier, turn index, raw text, normalized text, and acoustic feature vectors.

The server implements the emotion analysis processing unit as a trained classifier that maps a concatenated feature vector to an emotional state. The server constructs the concatenated feature vector by joining textual features and acoustic features, and optionally visual features. Textual features include, for example, term frequency–inverse document frequency values, contextual word embeddings produced by a transformer‑based encoder, and syntactic dependency indicators. Acoustic features include, for example, Mel‑frequency cepstral coefficients, pitch contour statistics, and speaking rate. Visual features are derived from facial images transmitted from the terminal, by applying a convolutional neural network that outputs expression probabilities.

The server, in one embodiment, employs a neural network classifier having multiple layers. The server configures an input layer to accept the concatenated feature vector, several hidden layers with nonlinear activation functions such as rectified linear units, and an output layer that produces a probability distribution over a finite set of emotional labels such as “joy,” “sadness,” “anger,” “anxiety,” and “neutral.” The server trains this classifier offline using labeled multi‑modal training data. During training, the server computes a loss function such as cross‑entropy between predicted and true labels, and updates network parameters by an optimization algorithm such as stochastic gradient descent with adaptive learning rates. The server applies regularization techniques such as dropout and weight decay to reduce overfitting. After training, the server stores the trained parameters in the storage device and loads them at runtime to perform inference. This concrete classifier structure and training process enables the server to map heterogeneous sensor data to a stable, high‑accuracy emotional state representation.

The server implements the situation analysis processing unit to determine situation information including position information and environment information. The server receives position information from the terminal as latitude and longitude coordinates, wireless access point identifiers, or short‑range beacon identifiers. The server stores a map of physical spaces, such as store layouts and home regions, as a graph structure in the storage device. The server applies a mapping algorithm that compares received identifiers with stored identifiers in the graph and determines, for example, that the user is in a store space, a living space, or a virtual space, and further identifies a sub‑region such as a “coffee section,” a “smartphone shelf,” or a “living room area.” The server records the situation information in association with the session identifier.

The server uses the emotional state and the situation information as inputs to a dialogue policy determination module. The server stores a policy table or policy model that maps combinations of emotional state, situation information, and user attribute information to dialogue policy parameters and response policy parameters. Dialogue policy parameters include, for example, target tone (friendly, calm, formal), target length (short, medium, long), and continuity level (whether to ask follow‑up questions). Response policy parameters include, for example, a response type class such as psychological support, product proposal, or neutral small talk. The server may implement this policy mapping as a rule‑based engine, a decision tree, or a small neural network that outputs policy codes.

The server constructs a prompt sentence for a generative AI model on the basis of the emotional state, the situation information, the dialogue policy, the response policy, user attribute information, and past dialogue history. The server stores the dialogue history as a structured sequence of records, each record including user input text, system output text, emotional state, situation information, and timestamps. The server applies a summarization algorithm, for example a transformer‑based encoder or a statistical key‑phrase extractor, to compress long histories into a shorter summary sentence, thereby reducing input length while preserving key facts. This reduces communication overhead with the generative AI model and improves computational efficiency because fewer tokens are processed per call.

The server then formats the prompt sentence by combining template segments with dynamically filled values. For example, the server may generate a prompt sentence such as:

“The user is a woman in her 30s who likes reading and has recently complained about work‑related stress. The current emotional state is ‘sadness’ with high intensity. The user has previously said that she feels exhausted after work. Please respond in a warm and concise tone, offer one or two concrete relaxation methods, and end with a gentle follow‑up question.”

In another context, the server may generate a prompt sentence such as:

“The customer is currently standing in the coffee section of a supermarket and appears curious but hesitant. The emotional state is neutral. Please propose one or two coffee products that are suitable for a beginner, mention a new blend, and invite the customer to try a sample.”

In a further context involving a child at home, the server may generate a prompt sentence such as:

“A child at home alone says: ‘Something bad happened at school today.’ The emotional state is ‘sadness’. Please respond like a kind friend, first acknowledging the child’s feelings, then inviting the child to talk more, and optionally suggesting a simple game to cheer them up.”

By using these structured prompt sentences, the server constrains and conditions the behavior of the generative AI model, which improves response stability and reduces variability that is unrelated to user needs.

The server interfaces with a generative AI model implemented as a transformer‑based language model. In one embodiment, the generative AI model is a multi‑layer transformer network comprising an input embedding layer, a plurality of self‑attention blocks with multi‑head attention mechanisms, feed‑forward sub‑layers, layer normalization, and a final projection layer to a vocabulary space. The generative AI model receives tokenized prompt sentences, predicts the next token probability distribution at each step, and generates text by sampling or greedy decoding according to the dialogue policy. The server performs tokenization and de‑tokenization using a subword encoding scheme such as byte‑pair encoding. The server operates the generative AI model on a separate computation resource such as a graphics processing unit cluster or a neural network accelerator, and advances tokens in batches for multiple sessions to improve throughput.

The server invokes the generative AI model by transmitting encoded prompt tokens and generation parameters such as maximum token length, temperature, and top‑k or top‑p sampling thresholds. The server receives output tokens and converts them into a dialogue sentence or a response sentence. The server applies a content filter that checks for prohibited words, unsafe phrases, and format anomalies. The server may also adjust the output length by truncating or requesting regeneration when certain criteria are not met. The server then transmits the validated text to the terminal.

The terminal, upon receiving the dialogue sentence or response sentence, displays the text on the screen and, if requested by control flags, outputs an audio rendering by using a text‑to‑speech engine. In one embodiment, the terminal uses a parametric or neural text‑to‑speech model to generate an audio waveform, which it then plays through the speaker. For a wearable device such as smart glasses, the terminal displays a short hint phrase overlay to guide a human staff member in real time.

The server records the generated response together with the corresponding prompt sentence and emotional state in the dialogue history. By accumulating this information, the server is able to detect long‑term patterns and refine future prompt sentences. The server controls the number of past turns referenced in a new prompt sentence to balance contextual richness with computational load. This internal control layer is not a mere automation of human conversation, but an engineered mechanism that optimizes the data given to the generative AI model to improve computational performance.

The system provides several technical effects. The server reduces communication load and processing time by summarizing past dialogue and by representing multi‑modal context as compact feature vectors. The server improves accuracy of emotion detection by using multi‑modal signals and a supervised neural classifier trained with an explicit loss function. The server improves consistency and determinism of generative outputs by structuring prompt sentences with explicit policy parameters and history summaries, rather than passing raw conversation logs. These measures decrease the number of failed or irrelevant generations, thereby reducing the total number of calls to the generative AI model, and enhance the throughput of the dialogue service on a given hardware configuration.

The server uses processing rules and non‑conventional steps that differ from human reasoning. A human operator typically responds directly to a user’s last utterance without explicitly computing multi‑dimensional feature vectors or emotional probability distributions. In contrast, the server performs explicit feature extraction, probability‑based classification, graph‑based situation mapping, and structured prompt composition. These procedures are optimized for machine execution and produce intermediate data structures, such as normalized embeddings, graph nodes, and policy codes, that have no direct analog in manual operation.

In an alternative embodiment, the server integrates the emotion analysis processing unit and the situation analysis processing unit into a single multi‑task neural network. The server designs this network with shared lower layers and task‑specific output heads. The shared layers encode textual and acoustic features, and one head predicts emotional labels while another head predicts situation classes such as store space, living space, or virtual space. During training, the server uses a combined loss function that is a weighted sum of an emotional classification loss and a situation classification loss. This architecture increases feature reuse and improves joint accuracy, which in turn improves the quality of prompt sentences and generated responses.

In another embodiment, the server maintains multiple generative AI models or model configurations tuned for different usage situations. For example, the server uses a model variant optimized for shorter outputs in store spaces and another variant optimized for empathetic long‑form dialogue in living spaces. The server selects which variant to invoke based on the situation information and includes in the prompt sentence a directive indicating the target style. This model selection and targeted prompting further reduces computation time and increases the relevance of generated content.

In yet another embodiment, the server uses a caching mechanism for prompt‑response pairs. When the server encounters an input pattern that falls into a previously seen cluster of feature vectors and situation information, the server retrieves a cached response template and adapts it minimally, instead of performing a full generative call. The server identifies such clusters by applying a clustering algorithm such as k‑means to embedding vectors derived from prompt sentences. This reduces average latency and decreases resource consumption while maintaining acceptable response quality for repetitive scenarios.

The system operates not only in purely virtual environments but also in direct connection with physical devices and real‑world behavior. In a store space, the terminal captures images of a shelf, positional data, and possibly ambient sound, and the server interprets this information to generate guidance messages that are displayed to a clerk on smart glasses. The clerk adjusts movements and speech in real time based on the guidance. Consequently, the system controls the timing, content, and style of human–machine interactions in a way that cannot be achieved by manual scripts alone. In a living space, the system adjusts notification frequency and modality to reduce disturbance when the emotional state indicates fatigue or stress.

Because the server performs structured multi‑modal fusion, efficient summarization, and policy‑driven prompt generation prior to invoking a generative AI model, the computer system achieves improvements in processing speed, response accuracy, and resource utilization compared with conventional systems that rely on ad‑hoc or unstructured prompts. The invention thus provides a concrete implementation that improves computer technology itself, rather than merely computerizing an existing human consultation process.

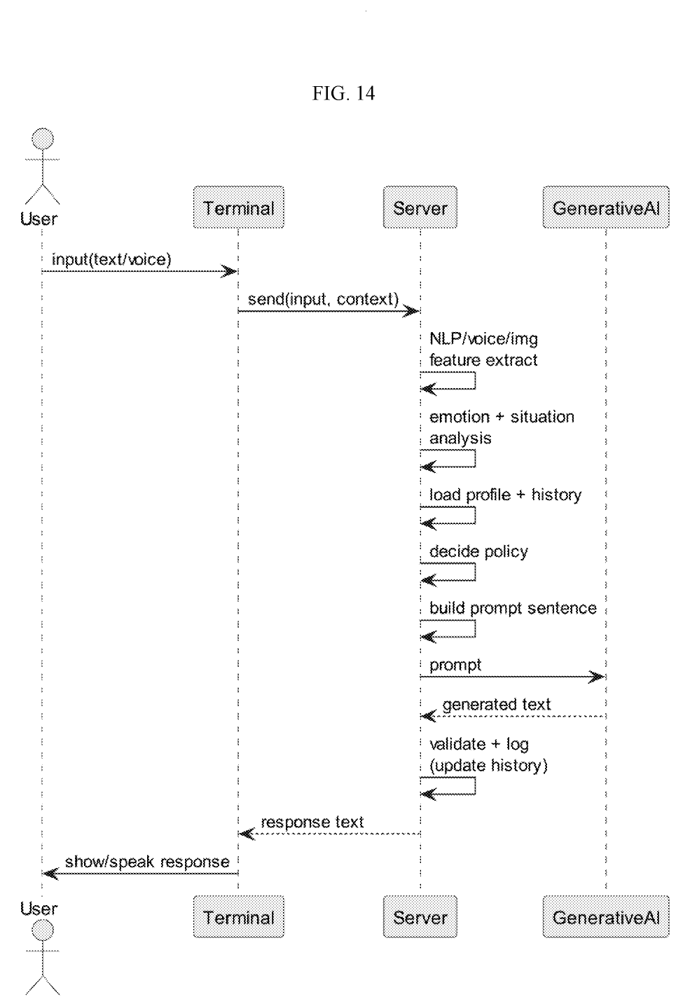

The following describes the processing flow using FIG. 14.

### Step 1

User provides initial input.

User enters character information or voice information using a terminal. As input, the user provides natural language content such as a concern, a question, or a casual utterance (for example, “Recently I feel very stressed about school” or “Today was such a fun day!”). As output, the user causes the terminal to acquire raw input data including at least one of text strings, audio waveforms, image frames, and basic metadata such as a timestamp.

### Step 2

Terminal acquires sensor data and formats a request.

Terminal receives the user’s input from the touch screen, keyboard, microphone, and camera. As input, the terminal uses the raw user text or audio, current position information from a GPS module or wireless access point, and optional image data from the camera. The terminal converts the voice information into digital audio samples and may perform on‑device speech‑to‑text decoding. The terminal then aggregates these values into a structured request object that includes fields such as session identifier, device identifier, position coordinates, text content, and binary attachments. As output, the terminal generates a network message suitable for transmission to the server.

### Step 3

Terminal transmits input information to the server.

Terminal sends the structured request object to the server via a communication interface. As input, the terminal uses the request object created in Step 2. The terminal encapsulates this object into packets using a communication protocol such as HTTPS over TCP/IP and addresses the packets to a predefined server endpoint. As output, the terminal produces a data stream on the network that the server can receive and reconstruct into the original structured request.

### Step 4

Server receives and stores raw interaction data.

Server accepts the network request from the terminal. As input, the server obtains the structured request including user text, audio references, image references, position information, and metadata. The server parses the request, validates the format, and writes the raw content into persistent storage, for example into a database table with columns for session identifier, user identifier, turn index, raw text, and sensor payload references. The server assigns or updates a session identifier to associate this turn with previous dialogue. As output, the server produces stored records that will serve as the basis for subsequent analysis.

### Step 5

Server performs linguistic preprocessing on character information.

Server takes the stored text segment as input. The server applies a natural language processing technique that performs tokenization, part‑of‑speech tagging, sentence segmentation, and dependency parsing. The server also extracts key phrases, named entities, and potential intent labels by pattern matching and statistical scoring. During this data processing, the server converts raw text into normalized tokens and feature vectors. As output, the server generates a structured linguistic feature set, including lists of tokens, part‑of‑speech tags, dependency trees, and semantic entities associated with the user’s text.

### Step 6

Server performs acoustic analysis on voice information.

Server uses the audio data from the request as input. When the request includes raw audio, the server applies a voice processing technique that performs feature extraction such as Mel‑frequency cepstral coefficients, pitch tracking, energy computation, and speaking rate estimation over time windows. The server may also apply speech‑to‑text decoding if the terminal did not convert the audio. The server thereby transforms continuous audio signals into numeric feature vectors aligned with time segments. As output, the server produces an acoustic feature representation and, when applicable, an additional text transcript for inclusion in later steps.

### Step 7

Server performs visual feature extraction for expression analysis.

Server takes image frames or video frames from the request as input. The server applies an image processing pipeline that normalizes resolution, detects faces, aligns facial landmarks, and feeds the aligned face regions into a convolutional neural network trained for expression recognition. The server converts pixel values into high‑dimensional feature vectors and then into probabilities over expression classes such as happiness, sadness, and surprise. As output, the server generates both intermediate visual feature vectors and final expression probability distributions that can be fused with other modalities.

### Step 8

Server fuses multi‑modal features and computes an emotional state.

Server collects linguistic features from Step 5, acoustic features from Step 6, and visual features from Step 7 as input. The server concatenates these feature vectors or processes them through a feature fusion layer, for example by mapping each modality into a common embedding space and then combining embeddings by concatenation or weighted summation. The server inputs the fused feature vector into an emotion analysis processing unit implemented as a trained neural classifier. The classifier computes a probability distribution over emotional labels via forward propagation and selects a label and intensity value based on maximum probability or thresholding. As output, the server yields an emotional state descriptor such as “sadness (0.82)” or “joy (0.75).”

### Step 9

Server determines situation information including position information.

Server uses the position information, device metadata, and optionally environment signals as input. The server compares the received coordinates, wireless identifiers, and beacon codes with a stored map of spaces, which may include a graph of store sections and a list of registered home regions. The server runs a matching algorithm that locates the closest node in the graph or region list. The server thereby classifies the usage situation as a store space, a living space, or a virtual space and also identifies sub‑regions such as a coffee section or a smartphone area. As output, the server produces situation information that includes at least a high‑level space class and a detailed position label.

### Step 10

Server consults user attribute information and past dialogue history.

Server retrieves user attribute information and dialogue history as input. The server accesses a profile record containing fields such as age group, preference categories, and previous consultation topics. The server also fetches recent turns in the dialogue history associated with the session identifier, including user messages, system responses, emotional states, and situation information. The server summarizes the history by using an algorithm such as key‑phrase extraction or sequence embedding with truncation to a maximum length. As output, the server obtains a compact context summary and an updated view of user attributes that will inform dialogue and response policies.

### Step 11

Server determines dialogue policy and response policy.

Server uses the emotional state from Step 8, the situation information from Step 9, and the user context from Step 10 as input. The server applies a policy decision mechanism, for example a rule set or a decision model, that maps these inputs to policy codes. The mapping may specify, for instance, that a user in sadness within a living space should receive empathetic and longer supportive messages, while a neutral user in a store space should receive concise product proposals. The server computes target tone, verbosity, and response type based on these rules. As output, the server generates a dialogue policy descriptor and a response policy descriptor, each encoded as a set of parameters.

### Step 12

Server generates a structured prompt sentence for the generative AI model.

Server uses the emotional state, the situation information, the dialogue policy, the response policy, user attribute information, and the dialogue history summary as input. The server fills a predefined textual template with these parameters, combining static instruction phrases with dynamic values. The server may include constraints such as “respond briefly” or “ask exactly one follow‑up question,” and describe context such as “the user is in a coffee section.” During this processing, the server concatenates textual fragments and inserts markers indicating emotional state and role. As output, the server produces a prompt sentence in natural language that encodes all relevant context for the generative AI model.

### Step 13

Server optionally generates or updates a consultation partner character description.

Server checks whether a consultation partner character already exists for the session. As input, the server uses user attribute information and, if a character is missing or outdated, current emotional state and consultation content. The server then constructs a character‑focused prompt sentence that instructs a generative AI model to define persona attributes such as age‑like tone, expertise area, and interaction style. The server obtains generated persona text and stores it as part of the session context. As output, the server yields an updated character description that can be referenced in subsequent prompt sentences to maintain dialog consistency.

### Step 14

Server encodes the prompt sentence and invokes the generative AI model.

Server takes the prompt sentence from Step 12 (and optionally the character description from Step 13) as input. The server applies a tokenizer to convert the prompt sentence into token identifiers, constructs a model input sequence, and sets generation parameters such as maximum length, sampling temperature, and top‑k or top‑p thresholds. The server submits this input sequence to a generative AI model implemented on a computation resource. The model performs attention‑based computations layer by layer and predicts the next tokens until an end condition is reached. As output, the server receives a sequence of token identifiers representing a dialogue sentence or response sentence.

### Step 15

Server decodes and validates the generated dialogue sentence or response sentence.

Server converts the output token identifiers into a text string by applying a de‑tokenizer and character decoder. As input, the server uses the raw generated text from the generative AI model. The server then checks whether the text satisfies constraints indicated by the dialogue policy, including length limits, presence of at least one question when required, and absence of prohibited expressions. The server may also run additional filters such as regular expression checks or rule‑based sanitization. As output, the server produces a validated dialogue sentence or response sentence that is ready to be delivered to the terminal.

### Step 16

Server records the new turn in the dialogue history.

Server uses the original user input, the determined emotional state, the situation information, the prompt sentence, and the generated response as input. The server creates a new history record including these elements, associates it with the session identifier, and writes the record into persistent storage. During this operation, the server may also update aggregated statistics such as total number of turns or cumulative emotional trends. As output, the server maintains an up‑to‑date dialogue history that can be queried in future steps to provide long‑term context.

### Step 17

Server transmits the generated response to the terminal.

Server uses the validated dialogue sentence or response sentence from Step 15 as input. The server constructs a response object that includes the text, optional flags indicating whether to use text‑to‑speech, and possibly a label indicating the response type such as “support” or “product suggestion.” The server serializes this object and sends it through the network interface to the terminal’s communication endpoint. As output, the server generates a network response stream carrying the system’s output text.

### Step 18

Terminal presents the response to the user or to a dialogue staff member.

Terminal receives the response object from the server as input. The terminal parses the object, extracts the text, and updates the user interface. For a user, the terminal renders the dialogue sentence or response sentence inside a chat window or notification area; for a dialogue staff member wearing smart glasses, the terminal overlays the response as a hint phrase. When the response object indicates voice output, the terminal invokes a text‑to‑speech engine, converts the text into an audio waveform, and plays it through the speaker. As output, the terminal produces a visual and/or auditory presentation that the user or staff member perceives.

### Step 19

User reacts to the response and optionally continues the dialogue.

User reads or listens to the dialogue sentence or response sentence presented by the terminal. As input, the user receives the content generated according to the emotional state and situation information. The user then decides whether to provide a new message, answer a question, move to another physical location, or terminate the interaction. When the user provides a new message or changes location, the user again generates input information for the terminal. As output, the user initiates a new cycle of interaction that will be processed starting from Step 1.

### Step 20

Server adjusts future processing based on updated emotion and context.

Server monitors subsequent turns and compares newly computed emotional states and situation information with previous values. As input, the server uses time series of emotional state descriptors, situation labels, and dialogue policies. The server detects trends such as improvement or worsening of mood or transitions between store sections. The server updates parameters in the dialogue policy and response policy, such as reducing intensity of support when emotion stabilizes or switching from exploration to recommendation in a store. As output, the server modifies future prompt sentences and policy codes, thereby refining the behavior of the generative AI model over time.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

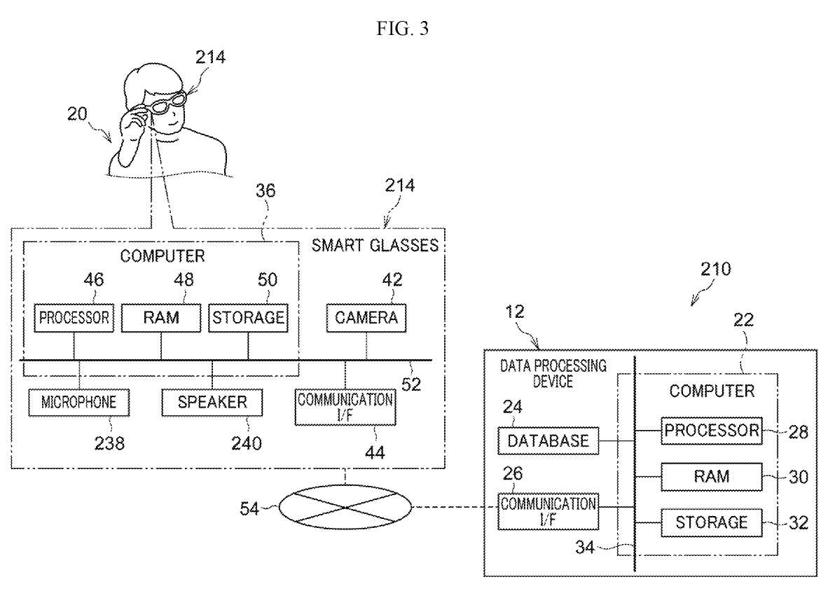

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

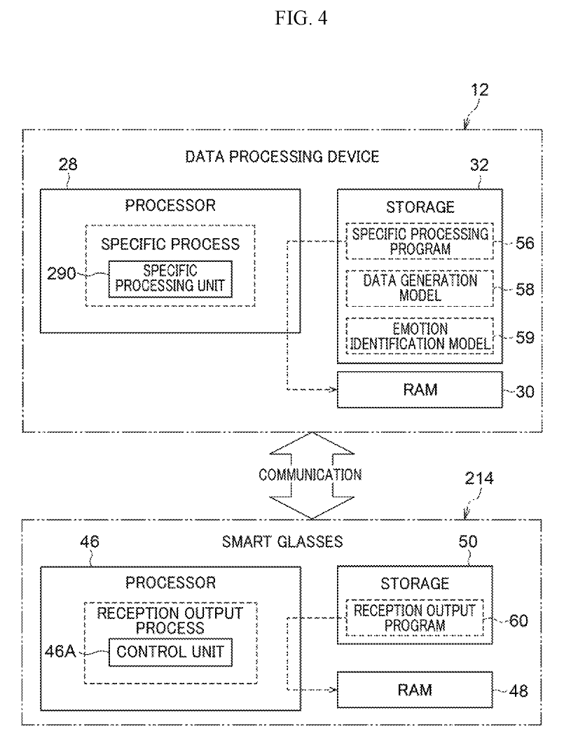

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

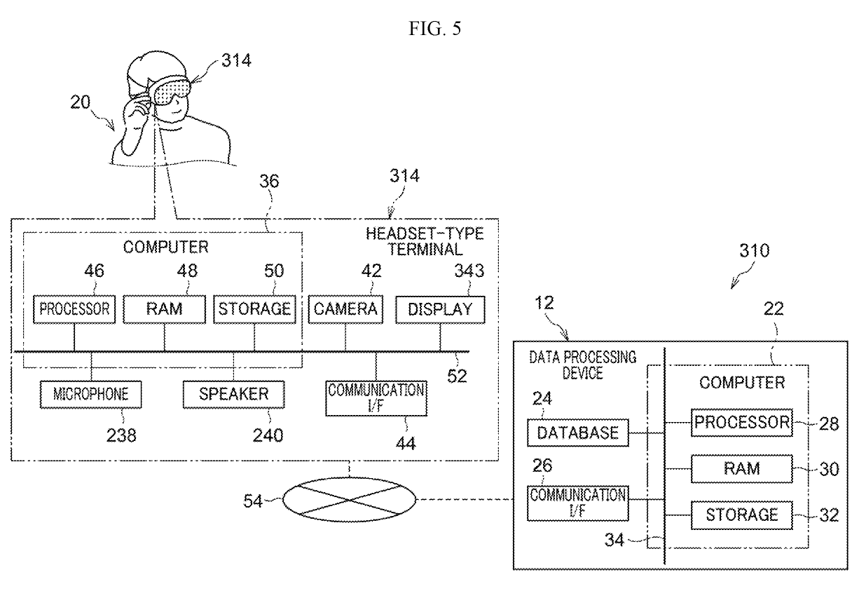

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

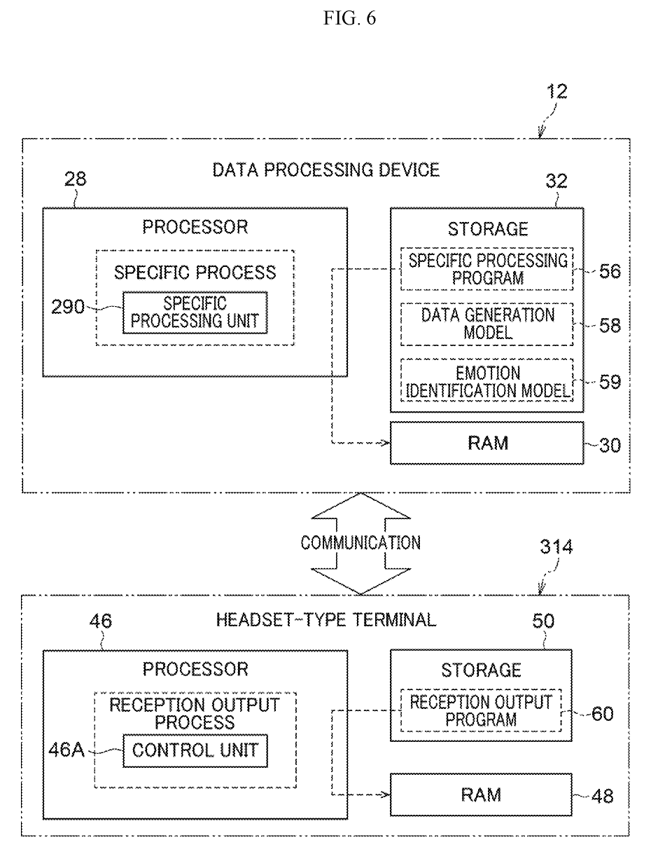

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

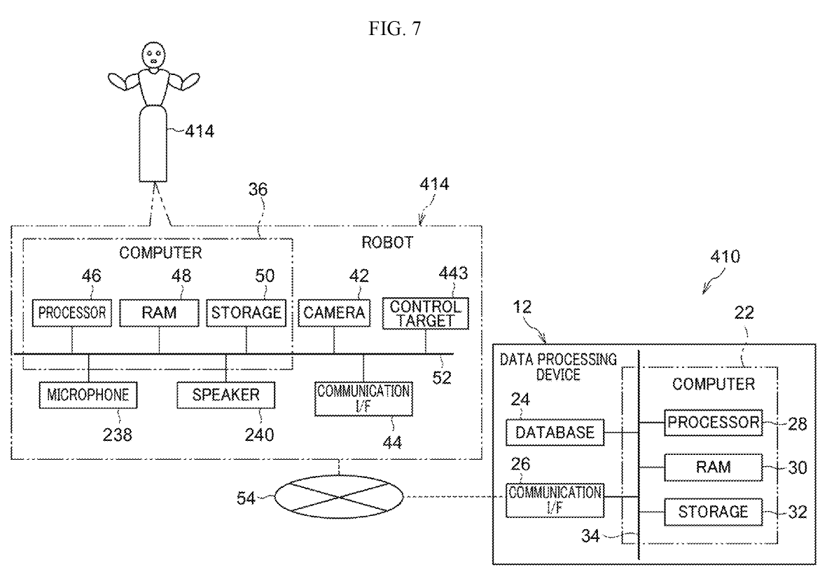

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

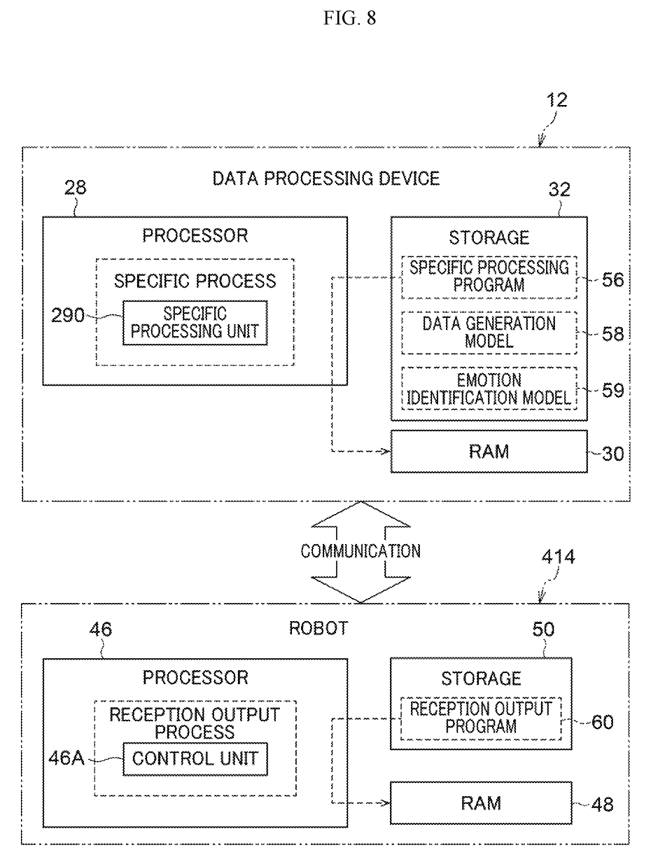

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

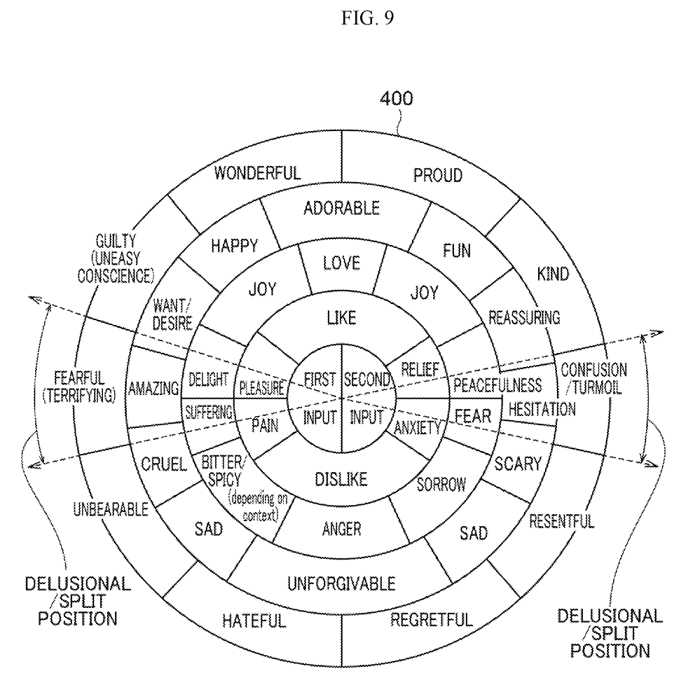

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o’clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don’t want to feel this way ever again” and “I don’t want to be chided again” is experienced in a robot. Another is a positive emotion in the area of “desire” on the reaction side. In other words, there are times when a positive feeling such as “desire more” and “want to know more” is experienced.

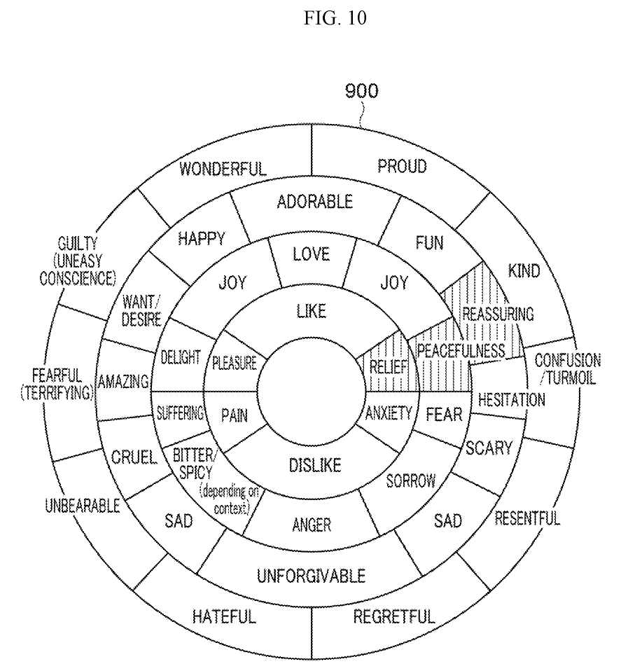

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,

wherein the processor is configured to

receive, from a terminal device, user attribute information and consultation content information and store the user attribute information and the consultation content information as structured information in a storage medium,

generate, on the basis of the user attribute information, the consultation content information, and past dialogue history information, a prompt sentence that describes, in a natural language, instruction content defining personality features, speaking style, and advice policy of a virtual counseling character, and construct the prompt sentence as input data to be supplied to a generative artificial intelligence model,

obtain, from the generative artificial intelligence model, output information including attribute information, utterance text information, and advice information of the virtual counseling character, analyze the output information to re‑structure the output information into profile information of the virtual counseling character and a plurality of pieces of advice information, and convert the re‑structured information into display data presentable to the terminal device,

generate, during continuation of dialogue with the virtual counseling character, conversation history data by combining the user attribute information, the consultation content information, the dialogue history information, and the profile information of the virtual counseling character, and incrementally update additional input prompt sentences including the conversation history data as input data to be supplied to the generative artificial intelligence model, and

store dialogue response information returned from the generative artificial intelligence model in association with the conversation history data, and present the dialogue response information to a user via the terminal device.

### Supplementary 2

The system according to supplementary 1,

wherein the processor is configured to

define, in a template format, condition information for specifying an age category, a tone category, and a specialty category of the virtual counseling character in accordance with age information, gender information, preference information, and concern content information included in the user attribute information, and embed the condition information into the prompt sentence so as to instruct the generative artificial intelligence model to generate a virtual counseling character optimized for the user.

### Supplementary 3

The system according to supplementary 1,

wherein the processor is configured to

analyze output text obtained from the generative artificial intelligence model on the basis of section labels, heading expressions, or formatting information, automatically divide the output text into name information of the virtual counseling character, personality description information, speaking style description information, initial message information, and a plurality of pieces of advice information, store the divided information as structured data, and determine a display format and a dialogue control method of a user interface on the terminal device using the structured data.

### Application Example 1

### Supplementary 1

A system comprising a processor,

wherein the processor is configured to

acquire attribute information and request content information received from a user via a terminal, and generate structured data including the attribute information and the request content information,

generate a prompt sentence based on the structured data, the prompt sentence defining personality information and role information of a virtual dialogue partner character corresponding to the user and instructing generation of advice regarding a product or a service by the virtual dialogue partner character,

input the prompt sentence into a generative artificial intelligence model and, by numerical computation processing performed by the generative artificial intelligence model, cause generation of dialogue information including profile information of the virtual dialogue partner character and advice information adapted to the attribute information and the request content information of the user,

extract attribute terms indicating at least one of color, category, price range, and usage purpose from the dialogue information, generate search conditions for a database in which information on the product or the service is stored based on the attribute terms, and acquire candidate information of a recommendation target from the database by using the search conditions,

generate response data including the profile information of the virtual dialogue partner character, the advice information, and the candidate information, and transmit the response data to the terminal to cause display on the terminal, and

acquire a selection result and a purchase processing result based on the candidate information from the user, record the selection result and the purchase processing result as user history information, and reflect the user history information as generation conditions when generating the prompt sentence in a subsequent processing.

### Supplementary 2

The system according to supplementary 1,

wherein the processor is configured to

acquire additional input information and dialogue history information transmitted from the terminal, generate an extended prompt sentence including the dialogue history information, and re-input the extended prompt sentence into the generative artificial intelligence model to cause continuous dialogue by the virtual dialogue partner character and updating of the advice information.

### Supplementary 3

The system according to supplementary 1,

wherein the processor is configured to

analyze emotion-related information acquired from the user and expressions included in the dialogue information obtained from the generative artificial intelligence model, and dynamically generate the prompt sentence so as to change at least one of a speaking manner, a tone, and contents of the candidate information presented by the virtual dialogue partner character in accordance with an emotional state of the user.

### Example 2

### Supplementary 1

A system comprising a processor,

wherein the processor is configured to

acquire user environment information and user input information so as to detect a situation of a user,

generate a prompt sentence by constructing a generative input text based on the situation of the user and past dialogue history,

input the prompt sentence to a generative artificial intelligence model and cause the generative artificial intelligence model to perform computation so as to generate a dialogue sentence adapted to the situation and an emotional state of the user,

transmit the generated dialogue sentence to a terminal device and cause the terminal device to present the generated dialogue sentence to the user by a voice output unit or a display output unit,

convert a response of the user, acquired from the terminal device, into character information, store the character information as dialogue history, and reuse the dialogue history for generation of the prompt sentence, and

determine, based on the situation of the user and the dialogue history, whether to continue a dialogue and a timing to start the dialogue, and control the generation of the prompt sentence and generation of the dialogue sentence by the generative artificial intelligence model according to a result of the determination.

### Supplementary 2

The system according to supplementary 1,

wherein the processor is configured to

determine, as the user environment information, whether the user is staying alone in a residential space in which a guardian is absent, based on detection data acquired from a sensor device or the terminal device, and reflect a result of the determination as the situation of the user in the generation of the prompt sentence.

### Supplementary 3

The system according to supplementary 1,

wherein the processor is configured to

add attribute information and interest information of the user together with the dialogue history to the generative input text prior to generation of the dialogue sentence, and include constraint information in the prompt sentence, the constraint information indicating that the dialogue sentence is for a minor and that a tone of the dialogue sentence provides a sense of security, and input the prompt sentence including the constraint information to the generative artificial intelligence model.

### Application Example 2

### Supplementary 1

A system comprising a processor,

wherein the processor is configured to

acquire input information from a user and analyze character information and voice information included in the input information by using a natural language processing technique and a voice processing technique,

identify, on the basis of the analysis, an emotional state of the user and situation information including position information by using an emotion analysis processing unit and a situation analysis processing unit, and determine a dialogue policy and a response policy in accordance with the emotional state and the situation information,

generate a prompt sentence for input to a generative information processing model on the basis of the emotional state, the situation information, the dialogue policy, the response policy, user attribute information, and past dialogue history,

input the prompt sentence to the generative information processing model and cause the generative information processing model to generate a dialogue sentence or a response sentence adapted to the emotional state and the situation information of the user,

transmit the generated dialogue sentence or response sentence to a terminal device and cause the terminal device to present the generated dialogue sentence or response sentence to the user or to a dialogue staff member who performs dialogue corresponding to the user, and

record new input information from the user and the generated dialogue sentence or response sentence as the dialogue history and, on the basis of the dialogue history, update the prompt sentence to continue multi‑turn dialogue.

### Supplementary 2

The system according to supplementary 1,

wherein the processor is configured to

generate, on the basis of the user attribute information, consultation content information, and the emotional state information, the prompt sentence including character setting information and speech style information for causing the generative information processing model to set a consultation partner character suitable for the user, and to instruct that a consistent dialogue be performed by the consultation partner character.

### Supplementary 3

The system according to supplementary 1,

wherein the processor is configured to

determine, on the basis of position information of the user, environment information, and the detected emotional state, whether a usage situation in a physical space is a store space, a living space, or a virtual space, and generate the prompt sentence for causing generation of at least one of a proposal sentence for a product or a service, a psychological support sentence, and a small‑talk sentence in accordance with a determination result.

What is claimed is:

1. A system comprising:
a communication interface coupled to a packet-switched network;
a storage device; and
circuitry configured to:
receive, via the communication interface, input data from a terminal device, and perform linguistic analysis and acoustic analysis on the input data using a natural language processing module and a voice processing module;
identify, based on results of the linguistic analysis and the acoustic analysis, an emotional state of a user and situation information, and determine a dialogue policy and a response policy in accordance with the emotional state and the situation information;
generate a structured prompt sentence for a generative neural network model based on the emotional state, the situation information, the dialogue policy, user attribute information stored in the storage device, and past dialogue history stored in the storage device;
input the prompt sentence to the generative neural network model and acquire, from the generative neural network model, a dialogue response adapted to the emotional state and the situation information;
transmit, via the communication interface, the dialogue response to the terminal device for presentation to the user; and
store the input data and the dialogue response as updated dialogue history in the storage device, and update the prompt sentence based on the updated dialogue history for subsequent multi-turn dialogue.

2. The system according to claim 1, wherein the circuitry is further configured to:
generate, based on the user attribute information and content information received from the terminal device, an instruction prompt sentence defining personality features, speaking style, and response policy for a virtual character profile, and input the instruction prompt sentence to the generative neural network model to generate character profile data.

3. The system according to claim 2, wherein the circuitry analyzes output data from the generative neural network model to extract the character profile data comprising attribute information, utterance style parameters, and a plurality of response template segments, and stores the character profile data in the storage device.

4. The system according to claim 3, wherein the circuitry includes the character profile data in subsequent prompt sentences to maintain consistent virtual character behavior across multi-turn dialogue sessions, and updates the character profile data based on accumulated user evaluation data.

5. The system according to claim 4, wherein the circuitry generates conversation history data by combining the user attribute information, the content information, the dialogue history, and the character profile data, and incrementally appends the conversation history data to additional prompt sentences supplied to the generative neural network model.

6. The system according to claim 1, wherein the emotional state is identified by invoking an emotion classification model that processes a feature vector extracted from the input data, the feature vector comprising at least text-derived sentiment scores and acoustic-derived prosodic features.

7. The system according to claim 6, wherein the prosodic features comprise fundamental frequency contour data, energy envelope data, and speech rate data extracted from voice data of the user, and the circuitry computes a weighted combination of the text-derived sentiment scores and the prosodic features to produce an emotion classification vector.

8. The system according to claim 7, wherein the circuitry selects the dialogue policy from among a plurality of predefined dialogue policy templates stored in the storage device based on the emotion classification vector, each dialogue policy template specifying response tone parameters, maximum response length, and topic constraint conditions.

9. The system according to claim 1, wherein the circuitry is further configured to:
acquire user environment information from at least one sensor device via the communication interface, determine a situation classification based on the user environment information and position information, and include the situation classification in the structured prompt sentence.

10. The system according to claim 9, wherein the circuitry determines, based on the situation classification and the dialogue history, whether to initiate a dialogue and a timing for initiating the dialogue, and controls generation of the prompt sentence according to a result of the determination.

11. The system according to claim 10, wherein the situation classification includes a constraint condition indicating that the dialogue response is adapted for a specific user category, and the circuitry includes the constraint condition in the prompt sentence to instruct the generative neural network model to generate responses conforming to the constraint condition.

12. The system according to claim 1, wherein the circuitry is further configured to:
convert the dialogue response from the generative neural network model into at least one of synthesized voice data and display text data, and transmit the synthesized voice data and the display text data to the terminal device via the communication interface.

13. The system according to claim 12, wherein the circuitry applies a voice synthesis model to convert text data of the dialogue response into the synthesized voice data, selecting voice parameters based on the character profile data stored in the storage device.

14. The system according to claim 1, wherein the circuitry is further configured to:
train an anomaly detection model on the dialogue history representing normal interaction patterns, compute a reconstruction error for newly received input data using the anomaly detection model, and generate an alert data record when the reconstruction error exceeds a predetermined threshold.

15. The system according to claim 14, wherein the circuitry, upon generating the alert data record, modifies the dialogue policy to a predefined escalation policy and generates a notification to a designated terminal device via the communication interface.

16. The system according to claim 1, wherein the circuitry performs fine-tuning of the generative neural network model by generating training data pairs comprising prompt sentences and corresponding user-evaluated dialogue responses from the dialogue history, and updating model parameters based on the training data pairs.

17. The system according to claim 1, wherein the circuitry maintains a sliding window of the most recent dialogue history entries in the prompt sentence, the sliding window having a configurable maximum token count, and summarizes older dialogue history entries into a compressed context representation for inclusion in the prompt sentence.

18. A system comprising:
a communication interface coupled to a packet-switched network;
a storage device; and
circuitry configured to:
receive, via the communication interface, input data comprising text data and voice data from a terminal device, perform linguistic analysis on the text data and acoustic analysis on the voice data, and identify an emotional state of a user based on a weighted combination of text-derived sentiment scores and acoustic-derived prosodic features;
determine a dialogue policy from among a plurality of predefined dialogue policy templates stored in the storage device based on the emotional state, and acquire situation information from sensor data received via the communication interface;
generate a structured prompt sentence for a generative neural network model comprising the emotional state, the situation information, the dialogue policy, user attribute information, character profile data, and past dialogue history stored in the storage device;
input the prompt sentence to the generative neural network model and acquire a dialogue response adapted to the emotional state and the situation information;
convert the dialogue response into at least one of synthesized voice data and display text data, and transmit, via the communication interface, the synthesized voice data and the display text data to the terminal device; and
store the input data and the dialogue response as updated dialogue history in the storage device, and update the prompt sentence based on the updated dialogue history.

19. The system according to claim 18, wherein the circuitry generates an instruction prompt sentence defining personality features, speaking style, and response policy for the character profile data, inputs the instruction prompt sentence to the generative neural network model, and stores resulting character profile data in the storage device for inclusion in subsequent prompt sentences.

20. A method comprising:
receiving, via a communication interface coupled to a packet-switched network, input data from a terminal device, and performing linguistic analysis and acoustic analysis on the input data using a natural language processing module and a voice processing module;
identifying, based on results of the linguistic analysis and the acoustic analysis, an emotional state of a user and situation information, and determining a dialogue policy and a response policy in accordance with the emotional state and the situation information;
generating a structured prompt sentence for a generative neural network model based on the emotional state, the situation information, the dialogue policy, user attribute information stored in a storage device, and past dialogue history stored in the storage device;
inputting the prompt sentence to the generative neural network model and acquiring, from the generative neural network model, a dialogue response adapted to the emotional state and the situation information;
transmitting, via the communication interface, the dialogue response to the terminal device for presentation to the user; and
storing the input data and the dialogue response as updated dialogue history in the storage device, and updating the prompt sentence based on the updated dialogue history for subsequent multi-turn dialogue.
